(19) United States
(12) Patent Application Publication
(10) Pub. No.: US 2014/0004450 A1
(43) Pub. Date: Jan. 2, 2014

(54) ELECTROPHOTOGRAPHIC PHOTOSENSITIVE MEMBER, METHOD OF PRODUCING ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, TOKYO (JP)

(72) Inventors: Ryoichi Tokimitsu, Kashiwa-shi (JP); Yuka Ishiduka, Suntou-gun (JP); Wataru Kitamura, Matsudo-shi (JP); Kenichi Kaku, Newcastle Upon Tyne (GB); Mai Murakami, Kashiwa-shi (JP)

(21) Appl. No.: 13/913,910

(22) Filed: Jun. 10, 2013

(30) Foreign Application Priority Data
Jun. 29, 2012 (JP) 2012-147154

(51) Int. Cl. G03G 15/00; G03G 21/18

(52) U.S. Cl. CPC G03G 5/04
USPC 430/56; 399/111; 399/159

(57) ABSTRACT

Provided is an electrophotographic photosensitive member in which an undercoat layer is a layer of which at least one selected from the group consisting of a compound represented by the formula (1), a compound represented by the formula (2), a compound represented by the formula (3) and a compound represented by the formula (4) can be detected by gas chromatography analysis when the undercoat layer is heated at 150° C. for 60 minutes by headspace method.

### BACKGROUND OF THE INVENTION

1. Field of the Invention

The present invention relates to an electrophotographic photosensitive member, a method of producing an electrophotographic photosensitive member, and a process cartridge and an electrophotographic apparatus each having an electrophotographic photosensitive member.

2. Description of the Related Art

An electrophotographic photosensitive member (organic electrophotographic photosensitive member) having an undercoat layer containing metal oxide particles and a photosensitive layer containing a charge generating substance and a charge transporting substance formed on the undercoat layer is sometimes used as an electrophotographic photosensitive member to be used in an electrophotographic apparatus.

The undercoat layer is provided for adjustment of an electric resistance (hereinafter abbreviated as “resistance”) as one purpose and incorporation of the metal oxide particles into the undercoat layer serves to reduce the resistance of the undercoat layer. This is because general metal oxide particles have oxygen defective sites and hence can reduce the resistance.

In recent years, suppression of a fluctuation of a light portion potential (potential fluctuation) at the time of repeated use has been required in association with an increase in speed of the electrophotographic apparatus (increase in process speed). Japanese Patent Application Laid-Open No. 2006-030700 discloses, as a technology for suppressing the fluctuation of the light portion potential, a technology involving incorporating zinc oxide particles provided with a compound having an anthraquinone structure into the undercoat layer of the electrophotographic photosensitive member. In addition, Japanese Patent Application Laid-Open No. 2004-219904 discloses a technology involving incorporating the following metal oxide particles into the undercoat layer. A diazo metal complex having optical absorption between 450 and 950 nm is placed on a surface of each of the metal oxide particles.

However, an investigation conducted by the inventors of the present invention has revealed the presence of the following problem. In association with the increase of the process speed of the electrophotographic apparatus, the fluctuation of the light portion potential at the time of long-term repeated use becomes remarkable under a high-temperature and high-humidity environment (e.g., a high-temperature and high-humidity environment having a temperature of 30° C. or more and a humidity of 85% RH or more). It has been found that each of the technologies disclosed in Japanese Patent Application Laid-Open No. 2006-030700 and Japanese Patent Application Laid-Open No. 2004-219904 is liable to cause the fluctuation of the light portion potential at the time of the long-term repeated use under the high-temperature and high-humidity environment in some cases.

### SUMMARY OF THE INVENTION

An object of the present invention is to provide an electrophotographic photosensitive member that suppresses a fluctuation of a light portion potential even when repeatedly used for a long time period under a high-temperature and high-humidity environment, and a method of producing the electrophotographic photosensitive member, and a process cartridge and an electrophotographic apparatus each having the electrophotographic photosensitive member.

The present invention relates to an electrophotographic photosensitive member, including: a support; an undercoat layer including a resin and metal oxide particles, formed on the support; and a photosensitive layer formed on the undercoat layer; in which the undercoat layer is a layer of which an azole compound is detected by gas chromatography analysis when the undercoat layer is heated at 150° C. for 60 minutes by headspace method, and the azole compound is at least one selected from the group consisting of a compound represented by the following formula (1), a compound represented by the following formula (2), a compound represented by the following formula (3) and a compound represented by the following formula (4),

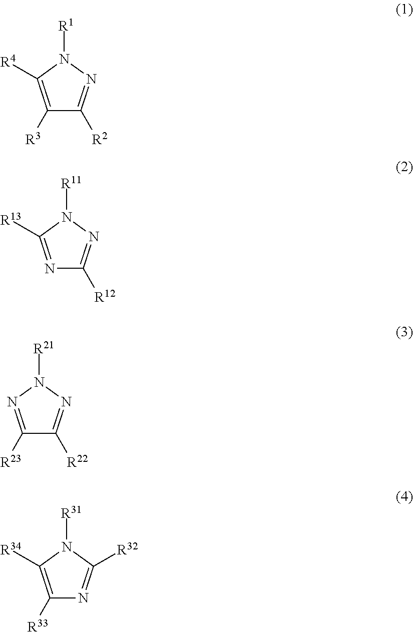

wherein, in the formulas (1) to (4), R¹ to R⁴, R¹¹ to R¹³, R²¹ to R²³ and R³¹ to R³⁴ each independently represents a hydrogen atom or an alkyl group having 1 to 3 carbon atoms.

The present invention also relates to a process cartridge detachably attachable to a main body of an electrophotographic apparatus, wherein the process cartridge integrally supports: the above-described electrophotographic photosensitive member, and at least one device selected from the group including of a charging device, a developing device, a transferring device, and a cleaning device.

The present invention also relates to an electrophotographic apparatus including: the above-described electrophotographic photosensitive member; a charging device, an exposure device, a developing device, and a transferring device.

The present invention also relates to a method of producing an electrophotographic photosensitive member which includes a support, an undercoat layer formed on the support and a photosensitive layer formed on the undercoat layer, including the steps of: forming a coat for the undercoat layer by using an undercoat-layer coating liquid comprising metal oxide particles, an isocyanate compound, a polyol resin and an azole compound; and heating the coat to form the undercoat layer;, in which the azole compound is at least one selected from the group consisting of a compound represented by the following formula (1), a compound represented by the following formula (2), a compound represented by the following formula (3) and a compound represented by the following formula (4),

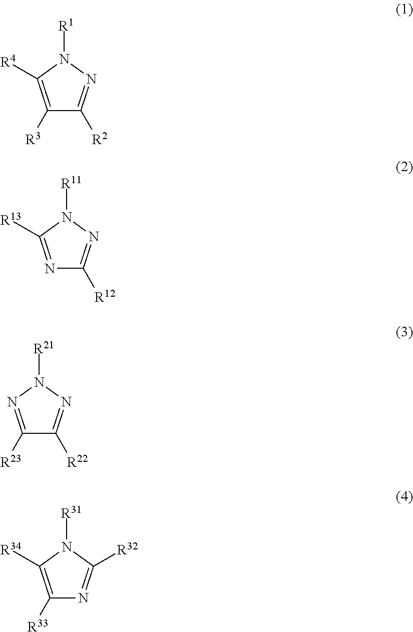

wherein, in the formulas (1) to (4), R¹ to R⁴_{, R}¹¹ to R¹³, R²¹ to R²³ and R³¹ to R³⁴ each independently represents a hydrogen atom or an alkyl group having 1 to 3 carbon atoms.

The present invention also relates to a method of producing an electrophotographic photosensitive member which includes a support, an undercoat layer formed on the support and a photosensitive layer formed on the undercoat layer, including the steps of: forming a coat for the undercoat layer by using an undercoat-layer coating liquid comprising metal oxide particles, a blocked isocyanate compound whose an isocyanate group has been blocked with an azole compound, and a polyol resin; and heating the coat to form the undercoat layer; in which the azole compound is at least one selected from the group consisting of a compound represented by the following formula (1), a compound represented by the following formula (2), a compound represented by the following formula (3) and a compound represented by the following formula (4),

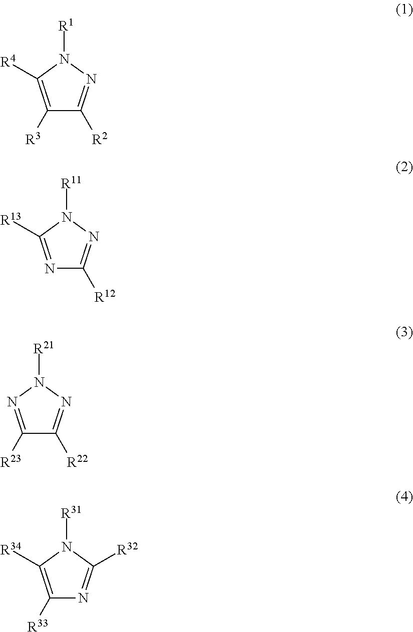

wherein, in the formulas (1) to (4), R¹ to R⁴, R¹¹ to R¹³, R²¹ to R²³, and R³¹ to R³⁴ each independently represents a hydrogen atom or an alkyl group having 1 to 3 carbon atoms.

According to the present invention, the electrophotographic photosensitive member excellent at suppressing the fluctuation of a light portion potential even when repeatedly used for a long time period under a high-temperature and high-humidity environment, and the method of producing the electrophotographic photosensitive member, and the process cartridge and electrophotographic apparatus each having the electrophotographic photosensitive member can be provided.

Further features of the present invention will become apparent from the following description of exemplary embodiments with reference to the attached drawings.

### BRIEF DESCRIPTION OF THE DRAWINGS

FIG. 1 is a view illustrating an example of the schematic construction of an electrophotographic apparatus including a process cartridge having an electrophotographic photosensitive member.

FIG. 2A is a view illustrating an example of the layer construction of an electrophotographic photosensitive member.

FIG. 2B is a view illustrating another example of the layer construction of the electrophotographic photosensitive member.

### DESCRIPTION OF THE EMBODIMENTS

An electrophotographic photosensitive member of the present invention is an electrophotographic photosensitive member having a support, an undercoat layer containing a resin and metal oxide particles, the layer being formed on the support, and a photosensitive layer formed on the undercoat layer. In addition, the member is that the undercoat layer is a layer of which at least one selected from the group consisting of a compound represented by the following formula (1), a compound represented by the following formula (2), a compound represented by the following formula (3) and a compound represented by the following formula (4) can be detected by gas chromatography analysis when the undercoat layer is heated at 150° C. for 60 minutes by headspace method. In other words, the member is that the undercoat layer contains a resin having a structure derived from the azole compound and/or the azole compound. In addition, when the undercoat layer contains the resin having a structure derived from the azole compound and/or the azole compound, the heating of the undercoat layer at 150° C. for 60 minutes by the headspace method vaporizes the azole compound liberated from the resin having a structure derived from the azole compound in the undercoat layer and/or the azole compound in the layer. Then, the azole compound is detected with the gas chromatography analysis.

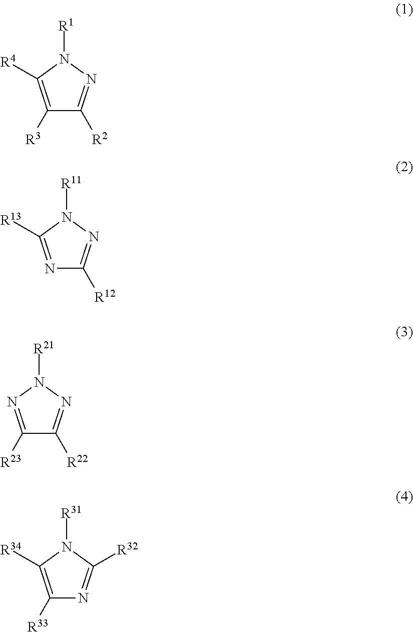

In the formulas (1) to (4), R¹ to R⁴, R¹¹ to R¹³, R²¹ to R²³ and R³¹ to R³⁴ each independently represents a hydrogen atom or an alkyl group having 1 to 3 carbon atoms.

The inventors of the present invention have assumed the reason why a potential fluctuation at the time of long-term repeated use under a high-temperature and high-humidity environment is suppressed by possessing the characteristics to be as described below.

The metal oxide particles in the undercoat layer generally have oxygen defective sites, which increase the carrier density of a conductor and hence reduce the resistance of each of the metal oxide particles. Then, the reduction of the resistance of each of the metal oxide particles improves electron conveyability.

However, the long-term repeated use of the electrophotographic photosensitive member results in the oxidation of the oxygen defective sites of the metal oxide particles by conduction deterioration, thereby establishing an electron-deficient state. It is assumed that the electron conveyability of each of the metal oxide particles reduces owing to the state and hence the resistance of the undercoat layer is liable to increase. Accordingly, a light portion potential at the time of the long-term repeated use largely fluctuates. Particularly under the high-temperature and high-humidity environment, the amount of moisture in the air is large, and hence the transfer of electrons from the oxygen defective sites of the metal oxide particles to water molecules is liable to occur and the sites are additionally liable to be oxidized by the conduction deterioration. Accordingly, the fluctuation of the light portion potential at the time of the long-term repeated use becomes remarkable under the high-temperature and high-humidity environment.

Meanwhile, the azole compound may be a compound having high reducing (electron-donating) power because the compound is of a five-membered ring structure having multiple nitrogen atoms. Accordingly, in the undercoat layer containing the resin having a structure derived from the azole compound and/or the azole compound, the oxidation of the metal oxide particles by the conduction deterioration may be suppressed by the reducing (electron-donating) power of the azole compound. Accordingly, it is assumed that the oxidation of the metal oxide particles is suppressed even under the high-temperature and high-humidity environment, and hence the fluctuation of the light portion potential at the time of the long-term repeated use is suppressed.

(Azole compound)

Hereinafter, specific examples of the compound represented by any one of the formulas (1) to (4) are described. However, the present invention is not limited thereto. Exemplified compounds (1-1) to (1-20) are specific examples of the compound represented by the formula (1). Exemplified compounds (1-21) to (1-28) are specific examples of the compound represented by the formula (2). Exemplified compounds (1-29) to (1-35) are specific examples of the compound represented by the formula (3). Exemplified compounds (1-36) to (1-42) are specific examples of the compound represented by the formula (4).

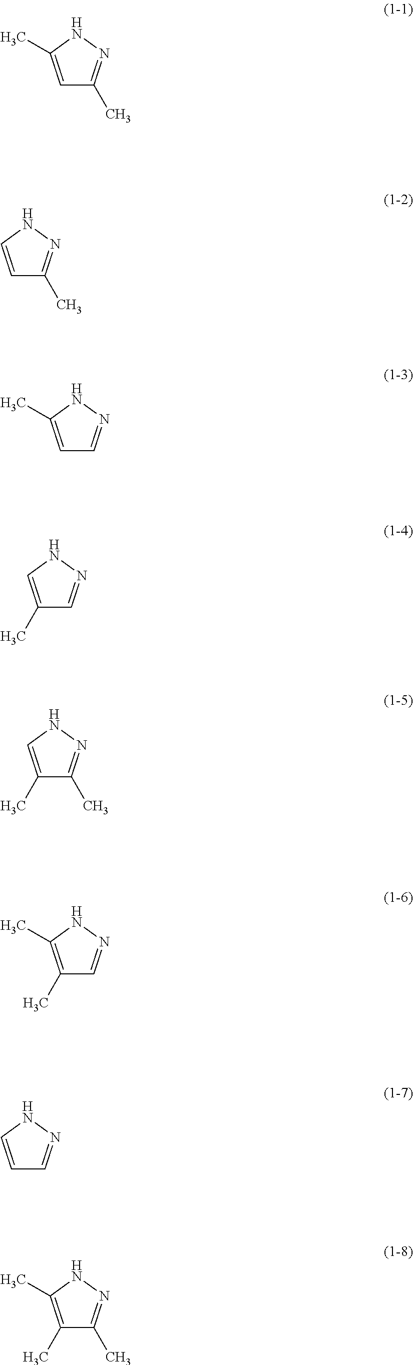

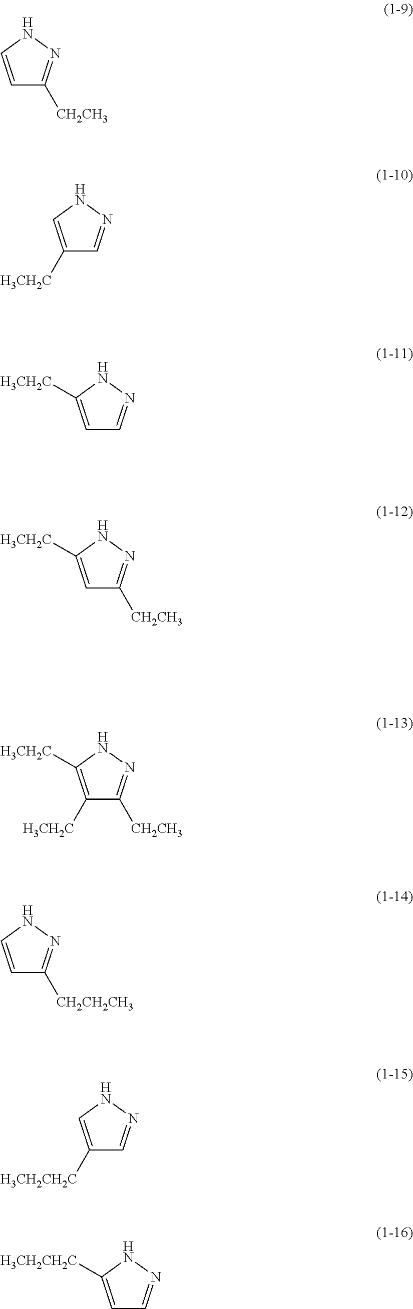

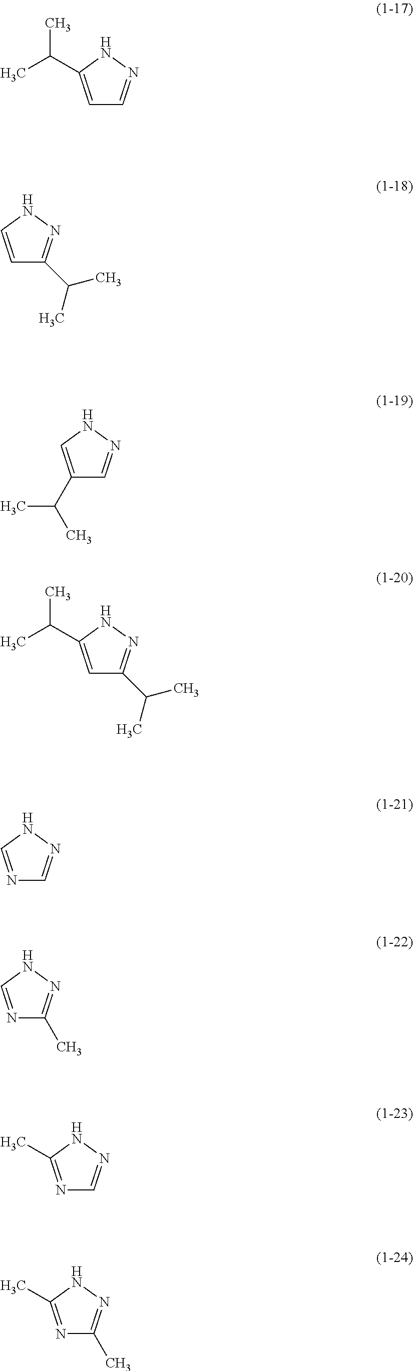

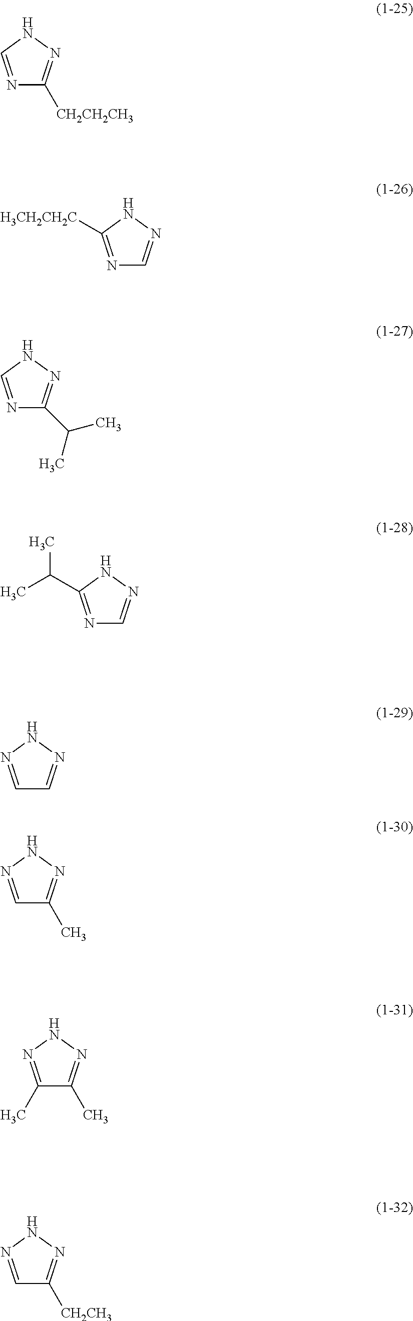

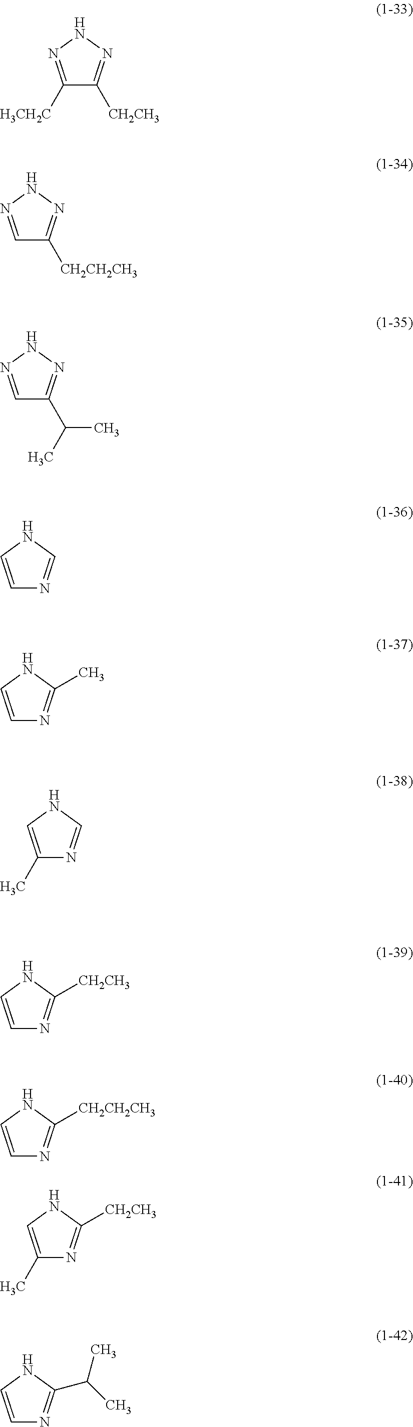

Of those, the compounds (1-1) to (1-35) are preferred, and in particular, the compounds (1-1) to (1-20) are more preferred. In particular, the compound represented by any one of the formulas (1) to (3) is additionally excellent at suppressing the fluctuation of the light portion potential at the time of the long-term repeated use because of the following reason. The compound is of a five-membered ring structure in which nitrogen atoms are adjacent to each other, and hence its reducing power against the metal oxide particles becomes high and the compound suppresses the oxidation of the metal oxide particles by the conduction deterioration with improved ease. Further, the compound represented by the formula (1) has a smaller number of nitrogen atoms than that of the compound represented by the formula (2) or (3). Accordingly, the reducing power of the compound represented by the formula (1) against the metal oxide particles becomes higher and hence the compound is more excellent at suppressing the fluctuation of the light portion potential at the time of the long-term repeated use.

In the present invention, the detectable amount of the azole compound to be detected by the method preferably satisfies the following formula (5).

5.0×10⁻⁷<A/B≦1.5×10⁻² (5)

In the formula (5), A represents a value (g/cm³) that the detectable amount (g) of the azole compound in the undercoat layer divided by a volume (cm³) of the undercoat layer, when the undercoat layer is heated at 150° C. for 60 minutes by the headspace method. In addition, B represents a value (g/cm³) that an amount (g) of the metal oxide particles divided by the volume (cm³) of the undercoat layer. When the undercoat layer contains the resin having a structure derived from the azole compound and/or the azole compound so as to satisfy the formula (5), the oxidation deterioration of the metal oxide particles is suppressed. Further, the following effect is obtained: the trapping of charge in the azole compound is suppressed and hence the potential fluctuation is suppressed.

As the azole compound, there may be used, for example, pyrazole, 3-methylpyrazole, 4-methylpyrazole, 3,5-dimethylpyrazole, 3,5-diisopropylpyrazole, imidazole, 4-methylimidazole, 2-ethylimidazole, 2-propylimidazole, 2-ethyl-4-methylimidazole, 2-isopropylimidazole, 1,2,3-triazole, 1,2,4-triazole (manufactured by Tokyo Chemical Industry Co., Ltd.), 3,4-dimethylpyrazole, 2-methylimidazole (manufactured by Sigma-Aldrich Co. LLC.).

In addition, as described in detail below, the resin having a structure derived from the azole compound is, for example, a resin obtained by using a blocked isocyanate compound whose isocyanate group has been blocked with the azole compound (such as a urethane resin).

(Metal Oxide Particles)

The metal oxide particles (metal oxide particles having oxygen defective sites) to be incorporated into the undercoat layer are preferably particles each containing at least one kind of metal oxide selected from the group consisting of titanium oxide, zinc oxide, tin oxide, zirconium oxide, and aluminum oxide. Of the particles containing the metal oxides, particles each containing zinc oxide (zinc oxide particles) are more preferred. This is probably because of the following reason. Each of the zinc oxide particles has tetrahedral coordination and has a wider space of a site to which oxygen adsorbs than that of a metal oxide particle having octahedral coordination, and hence the azole compound spatially reduces the oxidized portions of the metal oxide particles with improved ease.

The metal oxide particle may be a metal oxide particle whose surface has been treated with a surface treating agent such as a silane coupling agent. Examples of the silane coupling agent include N-2-(aminoethyl)-3-aminopropylmethyldimethoxysilane, 3-aminopropylmethyldiethoxysilane, (phenylaminomethyl)methyldimethoxysilane, N-2-(aminoethyl)-3-aminoisobutylmethyldimethoxysilane, N-ethylaminoisobutylmethyldiethoxysilane, N-methylaminopropylmethyldimethoxysilane, vinyltrimethoxysilane, 3-aminopropyltriethoxysilane, N-(2-aminoethyl)-3-aminopropyltrimethoxysilane, methyltrimethoxysilane, 3-glycidoxypropyltrimethoxysilane, 3-methacryloxypropyltrimethoxysilane, 3-chloropropyltrimethoxysilane, and 3-mercaptopropyltrimethoxysilane.

(Resin)

As a resin to be incorporated in the undercoat layer, there are given, for example, an acrylic resin, an allyl resin, an alkyd resin, an ethyl cellulose resin, an ethylene-acrylic acid copolymer, an epoxy resin, a casein resin, a silicone resin, a gelatin resin, a phenol resin, an urethane resin, a butyral resin, a polyacrylate resin, a polyacetal resin, a polyamide-imide resin, a polyamide resin, a polyallyl ether, a polyimide resin, a polyester resin, a polyethylene resin, a polycarbonate resin, a polystyrene resin, a polysulfone resin, a polyvinyl alcohol resin, a polybutadiene resin, and a polypropylene resin. Of those, an urethane resin is preferably used from the viewpoint of the suppression of a potential fluctuation under a high-temperature and high-humidity environment.

The urethane resin to be incorporated into the undercoat layer is formed of a polymer of a composition of an isocyanate compound or blocked isocyanate compound and a polyol resin.

Examples of the blocked isocyanate compound include blocked compounds of 2,4-tolylene diisocyanate, 2,6-tolylene diisocyanate, diphenylmethane-4,4′-diisocyanate, 1-isocyanato-3,3,5-trimethyl-5-isocyanatomethylcyclohexane (isophorone diisocyanate, IPDI), hexamethylene diisocyanate (HDI), an HDI-trimethylolpropane adduct, an HDI-isocyanurate, an HDI-biuret, and the like, each of which has been blocked with a blocking agent.

Examples of the blocking agent for the blocked isocyanate compound include: oxime-based compounds such as formaldehyde oxime, acetaldoxime, methyl ethyl ketoxime, cyclohexanone oxime, acetone oxime, and methyl isobutyl ketoxime; an active methylene-based compounds such as Meldrum's acid, dimethyl malonate, diethyl malonate, di-n-butyl malonate, ethyl acetate, and acetylacetone; amine-based compounds such as diisopropylamine, diphenylamine, aniline, and carbazole; imine-based compounds such as ethyleneimine and polyethyleneimine; acid imide-based compounds such as succinimide and maleimide; malonates; imidazole-based compounds such as imidazole, benzimidazole, and 2-methylimidazole; triazole-based compounds such as 1,2,3-triazole, 1,2,4-triazole, 4-amino-1,2,4-triazole, and benzotriazole; acid amide-based compounds such as acetanilide, N-methylacetamide, and acetamide; lactam-based compounds such as ε-caprolactam, δ-valerolactam, and γ-butyrolactam; urea-based compounds such as urea, thiourea, and ethyleneurea; sulfites such as sodium bisulfite; mercaptan-based compounds such as butylmercaptan and dodecylmercaptan; phenol-based compounds such as phenol and cresol; pyrazole-based compounds such as pyrazole, 3,5-dimethylpyrazole, and 3-methylpyrazole; and alcohol-based compounds such as methanol, ethanol, 2-propanol, and n-butanol. In addition, one kind of these blocking agents may be used alone or two or more kinds thereof may be used in combination to provide the blocked isocyanate compound.

In addition, the resin having a structure derived from the azole compound is, for example, a urethane resin obtained by the polymerization of a composition of the blocked isocyanate compound whose isocyanate group has been blocked with the azole compound and a polyol resin. Examples of the blocked isocyanate compound whose isocyanate group has been blocked with the azole compound include Desmodur BL3575/1 manufactured by Sumitomo Bayer Urethane Co., Ltd. and Duranate SBN-70D manufactured by Asahi Kasei Chemicals Corporation.

Examples of the polyol resin include a polyvinyl acetal resin and a polyphenol resin. Of those, a polyvinyl acetal resin is preferred.

A content ratio “metal oxide particles:resin” between the metal oxide particles and the resin is preferably 2:1 to 4:1 (mass ratio). When the mass ratio between the metal oxide particles and the resin is 2:1 to 4:1, the fluctuation of the light portion potential at the time of the repeated use is suppressed and the occurrence of cracking in the undercoat layer is suppressed.

The photosensitive layer of the electrophotographic photosensitive member of the present invention is preferably a laminated (separated-function) photosensitive layer separated into a charge generating layer containing a charge generating substance and a charge transporting layer containing a charge transporting substance. Further, the laminated photosensitive layer is preferably a forward-layer photosensitive layer obtained by laminating the charge generating layer and the charge transporting layer in the stated order from a support side from the viewpoints of electrophotographic characteristics.

FIGS. 2A and 2B are each a view illustrating an example of the layer construction of the electrophotographic photosensitive member of the present invention. In FIGS. 2A and 2B, the support is represented by reference numeral 101, the undercoat layer is represented by reference numeral 102, the photosensitive layer is represented by reference numeral 103, the charge generating layer is represented by reference numeral 104, and the charge transporting layer is represented by reference numeral 105.

As a general electrophotographic photosensitive member, a cylindrical electrophotographic photosensitive member produced by forming a photosensitive layer (a charge generating layer, a charge transporting layer) on a cylindrical support is widely used, but the member may be formed into a belt or sheet shape.

(Support)

The support is preferably conductive (conductive support) and a support made of a metal such as aluminum, stainless steel, copper, nickel, or zinc, or an alloy thereof may be used. In the case of a support made of aluminum or an aluminum alloy, the support to be used may be an ED tube or an EI tube or one obtained by subjecting the tube to cutting, electrochemical buffing, or a wet- or dry-honing process. In addition, there is given a metal support or a resin support having formed thereon a thin film made of a conductive material such as aluminum, an aluminum alloy, or an indium oxide-tin oxide alloy. The surface of the support may be subjected to, for example, a cutting treatment, a roughening treatment, or an alumite treatment. In addition, there may be used a support obtained by impregnating conductive particles such as carbon black, tin oxide particles, titanium oxide particles, or silver particles in a resin or the like, or a plastic having a conductive resin.

(Conductive layer)

A conductive layer may be provided between the support and the undercoat layer for the purpose of, for example, suppressing interference fringes due to the scattering of laser light or covering a flaw of the support.

The conductive layer is a layer formed by using a conductive-layer coating liquid obtained by dispersing conductive particles such as carbon black, metal particles, and metal oxide particles together with a resin and a solvent.

Examples of the resin to be used in the conductive layer include a polyester resin, a polycarbonate resin, a polyvinyl butyral resin, an acrylic resin, a silicone resin, an epoxy resin, a melamine resin, an urethane resin, a phenol resin, and an alkyd resin.

As a solvent to be used for the conductive-layer coating liquid, there are given, for example, an ether-based solvent, an alcohol-based solvent, a ketone-based solvent, and an aromatic hydrocarbon solvent. The thickness of the conductive layer is preferably 5 μm or more and 40 μm or less, more preferably 10 μm or more and 30 μm or less.

(Undercoat Layer)

The undercoat layer is provided between the support or the conductive layer and the photosensitive layer (the charge generating layer, the charge transporting layer).

The undercoat layer can be formed as described below. A coat of an undercoat-layer coating liquid obtained by subjecting the metal oxide particles, the resin or a raw material therefor, the azole compound represented by any one of the formulas (1) to (4), and a solvent to a dispersion treatment is formed. Next, the coat is heated and dried to provide the undercoat layer. Alternatively, the undercoat layer can be formed as described below. A coat of an undercoat-layer coating liquid obtained by subjecting the metal oxide particles, the resin having a structure derived from the azole compound represented by any one of the formulas (1) to (4) or a raw material therefor, and a solvent to a dispersion treatment is formed. Next, the coat is heated and dried to provide the undercoat layer.

As a method for the dispersion treatment, there are given methods using a homogenizer, an ultrasonic disperser, a ball mill, a sand mill, a roll mill, a vibration mill, an attritor, and a liquid collision-type high-speed disperser.

As a solvent to be used for the undercoat-layer coating liquid, there are given, for example, an alcohol-based solvent, a ketone-based solvent, an ether-based solvent, an ester-based solvent, a halogenated hydrocarbon-based solvent, and an aromatic solvent.

In addition, the undercoat layer may further contain organic resin particles or a leveling agent for the purpose of, for example, adjusting the surface roughness of the undercoat layer or reducing cracking in the undercoat layer. As the organic resin particle, there may be used: hydrophobic organic resin particles such as silicone particles; and hydrophilic organic resin particles such as crosslinked polymethyl methacrylate resin (PMMA) particles.

The undercoat layer may contain various additives. Examples of the additives include: metals such as aluminum powder and copper powder; conductive substances such as carbon black; electron transportable substances such as a quinone compound, a fluorenone compound, a oxadiazole-based compound, a diphenoquinone compound, an alizarin compound, and a benzophenone compound; electron transporting substances such as a condensed polycyclic compound and an azo compound; and organic metal compounds such as a metal chelate compound and a silane coupling agent.

The drying temperature of the coat of the undercoat-layer coating liquid is preferably 110° C. or more and 190° C. or less, more preferably 130° C. or more and 170° C. or less. In addition, the drying time is preferably 10 minutes or more and 120 minutes or less.

When the conductive layer is provided, the thickness of the undercoat layer is preferably 0.5 μm or more and 10 μm or less, more preferably 2 μm or more and 8 μm or less. When the conductive layer is not provided, the thickness is preferably 10 μm or more and 40 μm or less, more preferably 15 μm or more and 25 μm or less.

The photosensitive layer (the charge generating layer, the charge transporting layer) is formed on the undercoat layer.

When the photosensitive layer is a laminated photosensitive layer, the charge generating layer can be formed by: forming a coat of a charge generating-layer coating liquid obtained by dispersing the charge generating substance together with a binder resin and a solvent; and drying the coat. In addition, the charge generating layer may be a deposited film of the charge generating substance.

Examples of the charge generating substance include an azo pigment, a phthalocyanine pigment, an indigo pigment, a perylene pigment, a polycyclic quinone pigment, a squarylium dye, a thiapyrylium salt, a triphenylmethane dye, a quinacridone pigment, an azulenium salt pigment, a cyanine dyestuff, an anthanthrone pigment, a pyranthrone pigment, a xanthene dye, a quinoneimine dye, and a styryl dye. One kind of these charge generating substances may be used alone, or two or more kinds thereof may be used in combination. Of those, from the viewpoint of sensitivity, oxytitanium phthalocyanine, chlorogallium phthalocyanine, and hydroxygallium phthalocyanine are preferred.

When the photosensitive layer is a laminated photosensitive layer, examples of the binder resin to be used in the charge generating layer include a polycarbonate resin, a polyester resin, a butyral resin, a polyvinyl acetal resin, an acrylic resin, a vinyl acetate resin, and a urea resin. Of those, a butyral resin is particularly preferred. One kind of those resins may be used alone, or two or more kinds thereof may be used as a mixture or as a copolymer.

Examples of the dispersion method include one using a homogenizer, an ultrasonic disperser, a ball mill, a sand mill, a roll mill, or an attritor.

A ratio between the charge generating substance and binder resin in the charge generating layer is preferably such that the amount of the charge generating substance is 0.3 part by mass or more and 10 parts by mass or less with respect to 1 part by mass of the binder resin.

Examples of the solvent to be used for the charge generating-layer coating liquid include an alcohol-based solvent, a sulfoxide-based solvent, a ketone-based solvent, an ether-based solvent, an ester-based solvent, and an aromatic hydrocarbon solvent. The thickness of the charge generating layer is preferably 0.01 μm or more and 5 μm or less, more preferably 0.1 μm or more and 2 μm or less.

In addition, any of various sensitizers, antioxidants, UV absorbers, plasticizers, and the like may be added to the charge generating layer as required.

When the photosensitive layer is a laminated photosensitive layer, the charge transporting layer is formed on the charge generating layer.

The charge transporting layer can be formed by: forming a coat of a charge transporting-layer coating liquid obtained by dissolving the charge transporting substance and a binder resin in a solvent; and drying the coat.

Examples of the charge transporting substance include a triarylamine compound, a hydrazone compound, a styryl compound, a stilbene compound, and a butadiene compound. One kind of these charge transporting substances may be used alone, or two or more kinds thereof may be used in combination. Of those charge transporting substances, a triarylamine compound is preferred.

When the photosensitive layer is a laminated photosensitive layer, examples of the binder resin for the charge transporting layer include an acrylic resin, an acrylonitrile resin, an allyl resin, an alkyd resin, an epoxy resin, a silicone resin, a phenol resin, a phenoxy resin, a polyacrylamide resin, a polyamide-imide resin, a polyamide resin, a polyallyl ether resin, a polyarylate resin, a polyimide resin, a polyurethane resin, a polyester resin, a polyethylene resin, a polycarbonate resin, a polysulfone resin, a polyphenylene oxide resin, a polybutadiene resin, a polypropylene resin, and a methacrylic resin. Of those, a polyarylate resin and a polycarbonate resin are preferred. One kind of those resins may be used alone or two or more kinds thereof may be used as a mixture or a copolymer.

Examples of the solvent to be used for the charge transporting-layer coating liquid include an alcohol-based solvent, a sulfoxide-based solvent, a ketone-based solvent, an ether-based solvent, an ester-based solvent, and an aromatic hydrocarbon solvent.

A ratio between the charge transporting substance and binder resin in the charge transporting layer is preferably such that the amount of the charge transporting substance is 0.3 part by mass or more and 10 parts by mass or less with respect to 1 part by mass of the binder resin.

In addition, the drying temperature of the coat of the charge transporting-layer coating liquid is preferably 60° C. or more and 150° C. or less, more preferably 80° C. or more and 120° C. or less from the viewpoint of the suppression of cracking in the charge transporting layer. In addition, the drying time is preferably 10 minutes or more and 60 minutes or less.

When the charge transporting layer is a single layer, the thickness of the charge transporting layer is preferably 5 μm or more and 40 μm or less, more preferably 8 μm or more and 30 μm or less. When the charge transporting layer is of a laminated construction, the thickness of the charge transporting layer on the support side is preferably 5 μm or more and 30 μm or less, and the thickness of the charge transporting layer on the surface side is preferably 1 μm or more and 10 μm or less.

An antioxidant, a UV absorber, a plasticizer, or the like can be added to the charge transporting layer as required.

In addition, in the present invention, a protective layer (second charge transporting layer) may be formed on the photosensitive layer (charge transporting layer) for the purpose of, for example, protecting the photosensitive layer to improve its wear resistance or cleaning property.

The protective layer can be formed by: forming a coat of a protective-layer coating liquid obtained by dissolving a resin with an organic solvent; and drying the coat.

Examples of the resin to be used for the protective layer include a polyvinyl butyral resin, a polyester resin, a polycarbonate resin, a polyamide resin, a polyimide resin, a polyarylate resin, a polyurethane resin, a styrene-butadiene copolymer, a styrene-acrylic acid copolymer, and a styrene-acrylonitrile copolymer.

In addition, in order that the protective layer may be provided with a charge transporting ability, the protective layer may be formed by curing (polymerizing) a monomer material having the charge transporting ability or polymer-type charge transporting substance with various crosslinking or polymerization reactions. A layer obtained by curing a charge transportable compound having a chain-polymerizable functional group through polymerization or crosslinking is preferably formed. Examples of the chain-polymerizable functional group include an acrylic group, a methacrylic group, an alkoxysilyl group, and an epoxy group. Examples of the reactions for the curing include radical polymerization, ionic polymerization, thermal polymerization, photopolymerization, radiation polymerization (electron beam polymerization), a plasma CVD method, and a photo-CVD method.

The thickness of the protective layer is preferably 0.5 μm or more and 20 μm or less, more preferably 1 μm or more and 10 μm or less.

In addition, conductive particles, a UV absorber, a wear resistance improver, and the like can each be added to the outermost surface layer (the charge transporting layer, the protective layer) of the electrophotographic photosensitive member as required. Metal oxide particles such as tin oxide particles are preferred as the conductive particles. Examples of the wear resistance improver include fluorine atom-containing resin particles such as polytetrafluoroethylene particles, alumina, and silica.

For the application of each of the coating liquids corresponding to the above-mentioned respective layers, for example, any of the application methods may be employed, such as a dip coating method, a spray coating method, a spinner coating method, a roller coating method, a Meyer bar coating method, and a blade coating method.

(Electrophotographic Apparatus)

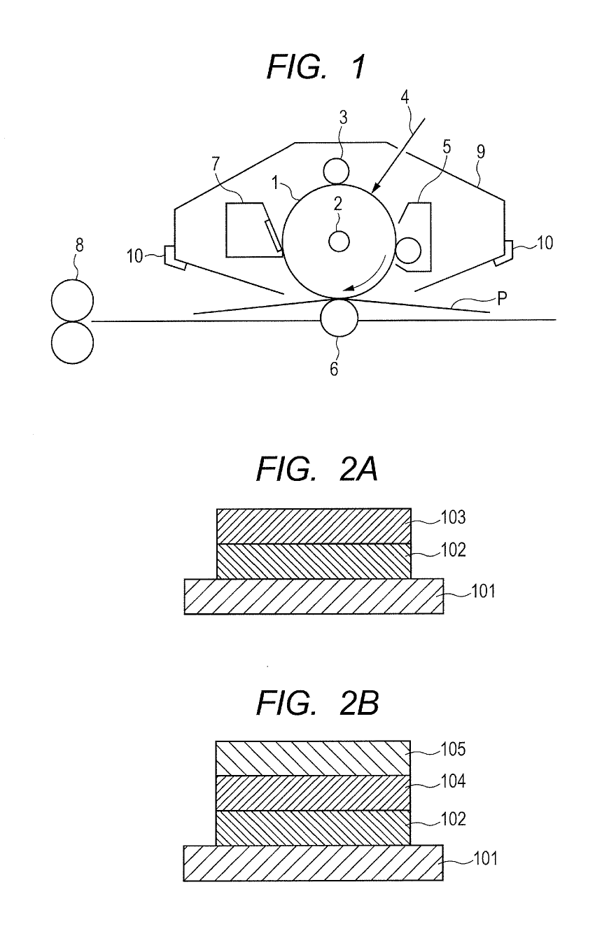

FIG. 1 illustrates an example of the schematic construction of an electrophotographic apparatus including a process cartridge having the electrophotographic photosensitive member.

In FIG. 1, a cylindrical electrophotographic photosensitive member 1 is rotationally driven about an axis 2 in a direction indicated by an arrow at a predetermined peripheral speed (process speed). The surface of the electrophotographic photosensitive member 1 to be rotationally driven is uniformly charged to a positive or negative predetermined potential by a charging device (a primary charging device: a charging roller or the like) 3 in a rotation process. Next, the surface receives exposure light 4 whose intensity is modulated according to a time-series electric digital image signal of image information of interest output from an exposure device (not shown) such as slit exposure or laser beam scanning exposure, which is light reflected from an original copy. Thus, electrostatic latent images corresponding to image information of interest are sequentially formed on the surface of the electrophotographic photosensitive member 1.

Next, the electrostatic latent images formed on the surface of the electrophotographic photosensitive member 1 are developed by normal development or reversal development with charged particles (toner) contained in a developer in a developing device 5 to provide toner images. Next, the toner images formed and carried on the surface of the electrophotographic photosensitive member 1 are sequentially transferred onto a transfer material (such as paper) P by a transfer bias from a transferring device (such as a transfer roller) 6. In this case, the transfer material P is taken out of a transfer material-supplying device (not shown) in synchronization with the rotation of the electrophotographic photosensitive member 1, and fed into a gap between the electrophotographic photosensitive member 1 and the transferring device 6 (abutting portion). In addition, a bias voltage opposite in polarity to the charge held by the toner is applied from a bias power source (not shown) to the transferring device 6.

The transfer material P onto which the toner images have been transferred is separated from the surface of the electrophotographic photosensitive member 1 and then introduced to a fixing device 8. The transfer material P is subjected to toner image fixation to be printed out as an image-formed product (print, copy) to the outside of the apparatus. When the transfer material P is an intermediate transfer member or the like, the transfer material P is subjected to image fixation after multiple transfer steps to be printed out.

The surface of the electrophotographic photosensitive member 1 after the transfer of the toner images is cleaned by removal of adhered matter such as the developer remaining after the transfer (transfer residual toner) by a cleaning device (such as cleaning blade) 7. In the case of a cleaner-less system, the transfer residual toner can be directly recovered with the developing device or the like. Further, the surface of the electrophotographic photosensitive member 1 is subjected to a discharge treatment with pre-exposure light (not shown) from a pre-exposure device (not shown) and then repeatedly used in image formation. It should be noted that the pre-exposure is not always required when the charging device 3 is a contact-charging device using a charging roller or the like as illustrated in FIG. 1.

In the present invention, of the above-mentioned components including the electrophotographic photosensitive member 1, the charging device 3, the developing device 5, and the cleaning device 7, multiple components may be housed in a container and integrally combined to construct a process cartridge. In addition, the process cartridge may be detachably attachable to the main body of an electrophotographic apparatus such as a copying machine or a laser beam printer. For example, the following can be adopted. At least one of the charging device 3, the developing device 5 and the cleaning device 7 is integrally supported together with the electrophotographic photosensitive member 1 to provide a cartridge, and the cartridge is turned into a process cartridge 9 to be detachably attachable to the main body of the apparatus with a guiding device 10 such as a rail of the main body of the apparatus.

The exposure light 4 is light reflected from or transmitted through an original copy when the electrophotographic apparatus is a copying machine or a printer. Alternatively, the exposure light 4 is light applied by, for example, scanning with a laser beam, the driving of an LED array, or the driving of a liquid crystal shutter array performed according to a signal converted from the original copy read with a sensor.

Hereinafter, the present invention is described in detail by way of specific examples. However, the present invention is not limited to the examples. It should be noted that the term “part(s)” in the examples means “part(s) by mass”. In addition, zinc oxide particles, titanium oxide particles, and tin oxide particles used here have oxygen defective sites.

### EXAMPLE 1

An aluminum cylinder having a diameter of 30 mm and a length of 357.5 mm was used as a support (conductive support).

Next, 100 parts of zinc oxide particles (specific surface area: 19 m²/g, powder resistance: 4.7×10⁶ Q·cm) as metal oxide particles were mixed with 500 parts of toluene by stirring. 1.5 Parts of a silane coupling agent (compound name: N-(2-aminoethyl)-3-aminopropyltrimethoxysilane, trade name: KBM603, manufactured by Shin-Etsu Chemical Co., Ltd.) were added to the mixture and then the resultant was stirred for 6 hours. After that, toluene was distilled off under reduced pressure, and then the residue was heated and dried at 140° C. for 6 hours to provide surface-treated zinc oxide particles.

Next, 15 parts of a butyral resin (trade name: BM-1, manufactured by SEKISUI CHEMICAL CO., LTD.) as a polyol resin and 15 parts of a blocked isocyanate compound (trade name: Desmodur BL3575/1, manufactured by Sumika Bayer Urethane Co., Ltd.) whose isocyanate group had been blocked with the compound represented by the formula (1-1) were dissolved in a mixed solution of 73.5 parts of methyl ethyl ketone and 73.5 parts of 1-butanol. 81 Parts of the surface-treated zinc oxide particles and 0.8 part of alizarin (manufactured by Tokyo Chemical Industry Co., Ltd.) were added to the solution, and then the mixture was dispersed with a sand mill apparatus using glass beads each having a diameter of 0.8 mm under an atmosphere having a temperature of 23±3° C. for 3 hours. After the dispersion, 0.01 part of a silicone oil (trade name: SH28PA, manufactured by Dow Corning Toray Co., Ltd.) and 5.6 parts of crosslinked polymethyl methacrylate resin (PMMA) particles (trade name: TECHPOLYMER SSX-102, manufactured by SEKISUI PLASTICS Co., Ltd., average primary particle diameter: 2.5 μm) as organic resin particles were added to the resultant, and then the mixture was stirred to prepare an undercoat-layer coating liquid. The undercoat-layer coating liquid was applied onto the support by dip coating and then the resultant coat was dried at 145° C. for 30 minutes to form an undercoat layer having a thickness of 20 μm.

Next, 4 parts of a hydroxygallium phthalocyanine crystal (electron generating substance) in a crystal form having strong peaks at Bragg angles 20±0.2° of 7.4° and 28.1° in the CuKα characteristic X-ray diffraction, and 0.04 part of the compound represented by the following structural formula (A) were added to a solution obtained by dissolving 2 parts of a polyvinyl butyral resin (trade name: S-LEC BX-1, manufactured by SEKISUI CHEMICAL CO., LTD.) in 100 parts of cyclohexanone. The resultant mixture was dispersed with a sand mill apparatus using glass beads each having a diameter of 1 mm under an atmosphere having a temperature of 23±3° C. for 1 hour. After the dispersion, 100 parts of ethyl acetate were added to the dispersion to prepare a charge generating-layer coating liquid. The charge generating-layer coating liquid was applied onto the undercoat layer by dip coating and then the resultant coat was dried at 90° C. for 10 minutes to form a charge generating layer having a thickness of 0.20 μm.

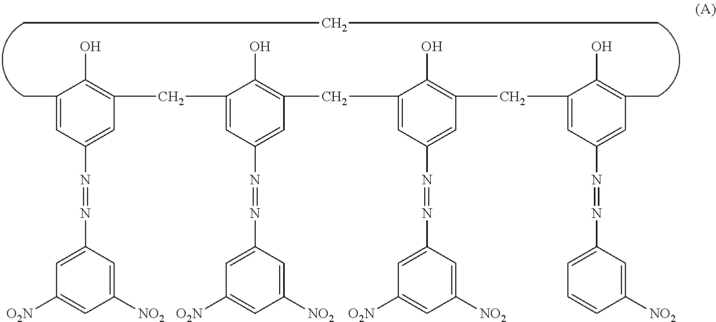

Next, 30 parts of a compound represented by the following structural formula (B) (charge transporting substance), 60 parts of a compound represented by the following structural formula (C) (charge transporting substance), 10 parts of a compound represented by the following structural formula (D), 100 parts of a polycarbonate resin (trade name: Iupilon 2400, manufactured by Mitsubishi Engineering-Plastics Corporation, bisphenol Z-type polycarbonate), and 0.02 part of a polycarbonate having a structural unit represented by the following structural formula (E) (viscosity-average molecular weight Mv: 20,000) were dissolved in a mixed solvent of 600 parts of mixed xylene and 200 parts of dimethoxymethane to prepare a charge transporting-layer coating liquid. The charge transporting-layer coating liquid was applied onto the charge generating layer by dip coating to form a coat and then the resultant coat was dried at 100° C. for 30 minutes to form a charge transporting layer having a thickness of 21 μm.

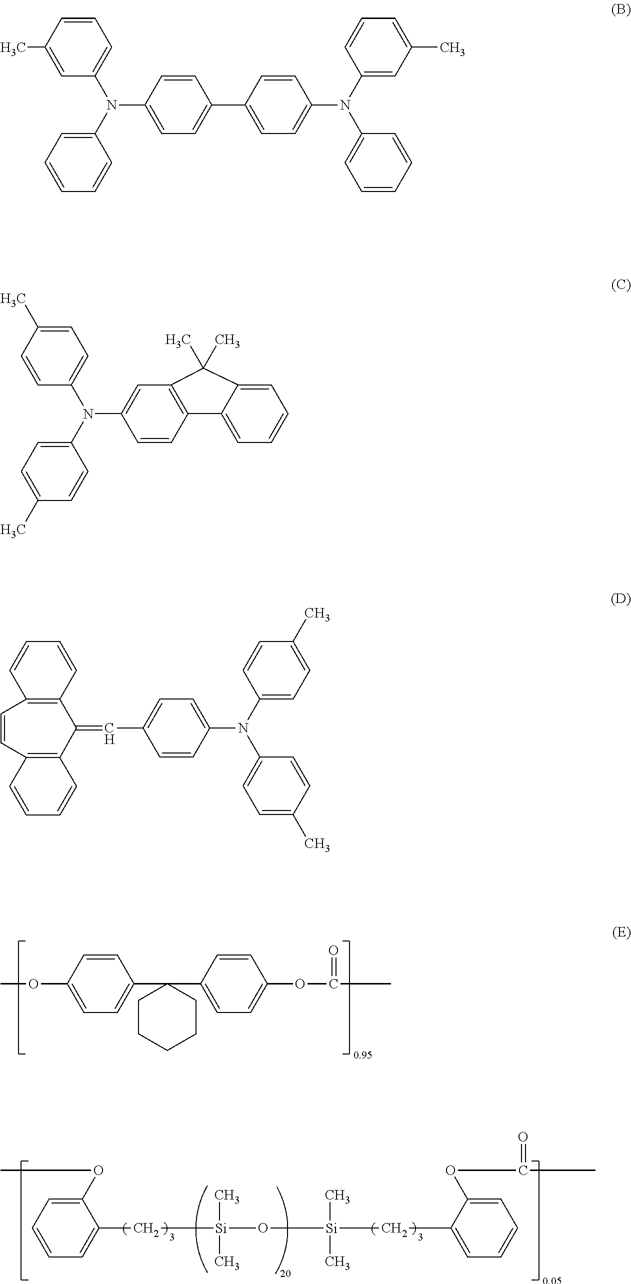

Next, 36 parts of a compound represented by the following formula (F) (charge transporting substance having an acrylic group as a chain-polymerizable functional group) and 4 parts of polytetrafluoroethylene resin fine powder (Lubron L-2, manufactured by DAIKIN INDUSTRIES, LTD.) were mixed in 60 parts of n-propyl alcohol, and then the contents were dispersed and mixed with an ultra-high pressure disperser to prepare a protective-layer coating liquid (second charge transporting-layer coating liquid).

The protective-layer coating liquid was applied onto the charge transporting layer by dip coating and then the resultant coat was dried at 50° C. for 5 minutes. After the drying, under a nitrogen atmosphere, the coat was cured by irradiating the coat with an electron beam under the conditions of an acceleration voltage of 70 kV and an absorbed dose of 8,000 Gy for 1.6 seconds while rotating the cylinder. After that, under the nitrogen atmosphere, the coat was subjected to a heating treatment for 3 minutes under such a condition that its temperature became 130° C. It should be noted that an oxygen concentration during a time period commencing on the irradiation with the electron beam and ending on the 3 minutes of heating treatment was ppm. Next, the coat was subjected to a heating treatment for 30 minutes in the air under such a condition that its temperature became 100° C. Thus, a protective layer (second charge transporting layer) having a thickness of 5 μm was formed.

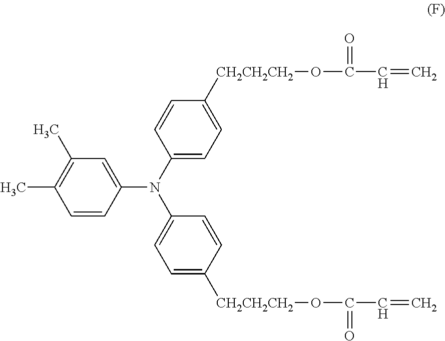

Thus, an electrophotographic photosensitive member having, on the support, the undercoat layer, the charge generating layer, the charge transporting layer, and the protective layer was produced. The member was defined as an electrophotographic photosensitive member for evaluating the fluctuation of a light portion potential. In addition, another electrophotographic photosensitive member was produced in the same manner as in the foregoing and defined as an electrophotographic photosensitive member for measurement.

The detectable amount (A) of the azole compound in the undercoat layer of the electrophotographic photosensitive member for measurement was calculated by the following headspace measurement method. The content (B (g/cm³)) of the metal oxide particles in the undercoat layer was calculated with an apparatus for thermogravimetry as described below.

(Headspace Measurement Method)

The charge transporting layer and the charge generating layer were peeled from the electrophotographic photosensitive member for measurement with a wrapping tape (C2000: manufactured by FUJIFILM Corporation) in a drum-tape polisher manufactured by Canon Inc. while the surface of the electrophotographic photosensitive member was observed. It should be noted that it was confirmed that the components of the charge transporting layer and the charge generating layer were not observed by an attenuated total reflection method (ATR method) of the FT-IR measurement methods. Next, a measurement portion measuring 1 cm (circumferential direction of the electrophotographic photosensitive member) by 4 cm (longitudinal direction of the electrophotographic photosensitive member) was cut out of the electrophotographic photosensitive member from which the charge transporting layer and the charge generating layer had been peeled, and was then placed in a headspace vial. After that, the vial was sealed with a septum. The sealed headspace vial was heated at 150° C. for 60 minutes, the vaporized azole compound was subjected to measurement with a GC/MS under the following conditions, and the area of a peak where the azole compound was detected in the resultant total ion chromatogram was determined. Next, a calibration curve was created by using the azole compound detected by the headspace method as a reference substance for a calibration curve and then the detectable amount (A (g/cm³)) of the azole compound was calculated from the foregoing peak area.

<Conditions>

(Pretreatment Conditions)

Headspace sampler: Turbo Matrix HS40 (manufactured by Thermo Fisher Scientific)
Extraction condition: 150° C.×60 min

(GC/MS Measurement Conditions)
GC: TRACEGC ULTRA
MS: JEOL AX-500
Separating column: HP-5MS (60 m×0.25 mm ID, Df=0.25 μm)
Column temperature: The temperature was held at 40° C. for 3 minutes and then the column was heated to 70° C. at a rate of temperature increase of 2° C./min. Further, the column was heated to 150° C. at a rate of temperature increase of 5° C./min and then heated to 300° C. at a rate of temperature increase of 10° C./min. After that, the temperature was held at 300° C. for 1 minute.
Ionization chamber temperature: 250° C.
GC/MS interface temperature: 250° C.
Carrier gas: He 150 KPa
Ionization mode: EI, 70 eV
Scanning range: mass number m/z=40 to 460
Injection mode: split (split flow: 10 mL/min, column flow rate: 1 mL)

(Method of Measuring Content of Metal Oxide Particles)

A measurement portion measuring 1 cm by 1 cm was cut out of the electrophotographic photosensitive member from which the charge transporting layer and the charge generating layer had been peeled, the undercoat layer was stripped off the portion, and the resultant was placed in a thermogravimetry/differential thermal analyzer (manufactured by Seiko Instruments Inc.: TG/DTA220U). The resultant was heated from normal temperature (23° C.±3° C.) to 600° C. under a nitrogen atmosphere at a rate of temperature increase of 20° C./min and then held at the temperature for 30 minutes. A remaining weight (mass of a metal oxide) after the holding was determined, and a value obtained by dividing the remaining weight by the volume of the undercoat layer (the area of the measurement portionxthe thickness of the undercoat layer) was defined as the content (B (g/cm³)) of the metal oxide particles per unit volume. A ratio A/B was determined from the calculated A and B in the undercoat layer. Table 1 shows the result.

### EXAMPLE 2

An electrophotographic photosensitive member was produced in the same manner as in Example 1 except that in Example 1, 0.81 part of alizarin (manufactured by Tokyo Chemical Industry Co., Ltd.) in the undercoat-layer coating liquid was changed to 0.41 part of 2,3,4-trihydroxybenzophenone (manufactured by Tokyo Chemical Industry Co., Ltd.). In addition, the ratio A/B in the undercoat layer was determined in the same manner as in Example 1. Table 1 shows the result.

### EXAMPLES 3 TO 5

Electrophotographic photosensitive members were each produced in the same manner as in Example 2 except that in Example 2, the drying conditions were changed to conditions shown in Table 1. In addition, the ratio A/B in each undercoat layer was determined in the same manner as in Example 2. Table 1 shows the results.

### EXAMPLE 6

An electrophotographic photosensitive member was produced in the same manner as in Example 2 except that in Example 2, 0.007 part of dioctyltin dilaurate was added to the undercoat-layer coating liquid and the drying conditions were changed to conditions shown in Table 1. In addition, the ratio A/B in the undercoat layer was determined in the same manner as in Example 2. Table 1 shows the result.

### EXAMPLE 7

An electrophotographic photosensitive member was produced in the same manner as in Example 2 except that in Example 2, 0.15 part of an aluminum organic compound (compound name: aluminum ethylacetoacetate/diisopropylate, trade name: ALCH, manufactured by Kawaken Fine Chemicals Co., Ltd.) was added to the undercoat-layer coating liquid and the drying conditions were changed to conditions shown in Table 1. In addition, the ratio A/B in the undercoat layer was determined in the same manner as in Example 2. Table 1 shows the result.

### EXAMPLE 8

An electrophotographic photosensitive member was produced in the same manner as in Example 2 except that in Example 2, 0.15 part of an aluminum organic compound (compound name: aluminum trisethylacetoacetate, trade name: ALCH-TR, manufactured by Kawaken Fine Chemicals Co., Ltd.) was added to the undercoat-layer coating liquid and the drying conditions were changed to conditions shown in Table 1. In addition, the ratio A/B in the undercoat layer was determined in the same manner as in Example 2. Table 1 shows the result.

### EXAMPLE 9

An electrophotographic photosensitive member was produced in the same manner as in Example 2 except that in Example 2, 0.15 part of an aluminum organic compound (compound name: aluminum trisacetylacetonate, trade name: Alumichelate A(W), manufactured by Kawaken Fine Chemicals Co., Ltd.) was added to the undercoat-layer coating liquid and the drying conditions were changed to conditions shown in Table 1. In addition, the ratio A/B in the undercoat layer was determined in the same manner as in Example 2. Table 1 shows the result.

### EXAMPLE 10

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

100 Parts of zinc oxide particles (specific surface area: 19 m²/g, powder resistance: 4.7×10⁶ Q·cm) were mixed with 500 parts of toluene by stirring. 1.5 Parts of a silane coupling agent “KBM603” were added to the mixture and then the resultant was stirred for 6 hours. After that, toluene was distilled off under reduced pressure, and then the residue was heated and dried at 140° C. for 6 hours to provide surface-treated zinc oxide particles.

Next, 15 parts of a butyral resin “BM-1” as a polyol resin and 15 parts of a blocked isocyanate compound (trade name: Sumidur BL3175, manufactured by Sumika Bayer Urethane Co., Ltd., compound whose isocyanate group had been blocked with an oxime compound) were dissolved in a mixed solution of 73.5 parts of methyl ethyl ketone and 73.5 parts of 1-butanol. 81 Parts of the surface-treated zinc oxide particles, 10.9 parts of the compound represented by the formula (1-1), and 0.41 part of 2,3,4-trihydroxybenzophenone were added to the solution, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to provide an undercoat-layer coating liquid. The undercoat-layer coating liquid was applied onto the support by dip coating and then the resultant coat was dried at 145° C. for 30 minutes to form an undercoat layer having a thickness of 20 μm.

### EXAMPLES 11 TO 22

Electrophotographic photosensitive members were each produced in the same manner as in Example 10 except that in Example 10, the kind and content of the azole compound were changed to an exemplified compound shown in Table 1, and the conditions for the drying of the undercoat layer were changed to conditions shown in Table 1. In addition, the ratio A/B in each undercoat layer was determined in the same manner as in Example 10. Table 1 shows the results.

### EXAMPLE 23

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

100 Parts of zinc oxide particles (specific surface area: 18 m²/g, powder resistance: 4.0×10⁶ Q·cm) were mixed with 500 parts of toluene by stirring. 1.5 Parts of a silane coupling agent “KBM603” were added to the mixture and then the resultant was stirred for 6 hours. After that, toluene was distilled off under reduced pressure, and then the remainder was heated and dried at 140° C. for 6 hours to provide surface-treated zinc oxide particles.

Next, 81 parts of the surface-treated zinc oxide particles, 30 parts of a resol-type phenol resin (trade name: plyophen J325, manufactured by DIC Corporation, ammonia catalyst, solid content: 70%), 10.9 parts of the compound represented by the formula (1-1), 0.81 part of alizarin (manufactured by Tokyo Chemical Industry Co., Ltd.), 73.5 parts of methyl ethyl ketone, and 73.5 parts of 1-butanol were added, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to provide an undercoat-layer coating liquid. The undercoat-layer coating liquid was applied onto the support by dip coating and then the resultant coat was dried at 145° C. for 30 minutes to form an undercoat layer having a thickness of 20 μm. Table 1 shows the result.

### EXAMPLES 24 AND 25

Electrophotographic photosensitive members were each produced in the same manner as in Example 23 except that in Example 23, the conditions for the drying of the undercoat layer were changed to conditions shown in Table 1. In addition, the ratio A/B in each undercoat layer was determined in the same manner as in Example 23. Table 1 shows the results.

### EXAMPLE 26

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

100 Parts of zinc oxide particles (specific surface area: 18 m²/g, powder resistance: 4.0×10⁶ Q·cm) were mixed with 500 parts of toluene by stirring. 1.5 Parts of a silane coupling agent “KBM603” were added to the mixture and then the resultant was stirred for 6 hours. After that, toluene was distilled off under reduced pressure, and then the remainder was heated and dried at 140° C. for 6 hours to provide surface-treated zinc oxide particles.

Next, 81 parts of the surface-treated zinc oxide particles, 30 parts of an N-methoxymethylated 6-nylon resin (trade name: Toresin EF-30T, manufactured by Nagase ChemteX Corporation), 10.9 parts of the compound represented by the formula (1-1), 0.41 part of 2,3,4-trihydroxybenzophenone, 73.5 parts of methyl ethyl ketone, and 73.5 parts of 1-butanol were added, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to provide an undercoat-layer coating liquid. The undercoat-layer coating liquid was applied onto the support by dip coating and then the resultant coat was dried at 145° C. for 30 minutes to form an undercoat layer having a thickness of 3.0 μm.

### EXAMPLE 27

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

100 Parts of zinc oxide particles (specific surface area: 18 m²/g, powder resistance: 4.0×10⁶ Q·cm) were mixed with 500 parts of toluene by stirring. 1.5 Parts of a silane coupling agent “KBM603” were added to the mixture and then the resultant was stirred for 6 hours. After that, toluene was distilled off under reduced pressure, and then the remainder was heated and dried at 140° C. for 6 hours to provide surface-treated zinc oxide particles.

Next, 90 parts of the surface-treated zinc oxide particles, 18 parts of an alkyd resin (BECKOLITE M6401-50-S, manufactured by DIC Corporation), 10 parts of a melamine resin (SUPER BECKAMINE L-145-60, manufactured by DIC Corporation), 10.9 parts of the compound represented by the formula (1-1), 0.41 part of 2,3,4-trihydroxybenzophenone, and 72 parts of methyl ethyl ketone were added, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to provide an undercoat-layer coating liquid. The undercoat-layer coating liquid was applied onto the support by dip coating and then the resultant coat was dried at 145° C. for 30 minutes to form an undercoat layer having a thickness of 3.0 μm.

### EXAMPLES 28 AND 31

Electrophotographic photosensitive members were each produced in the same manner as in Example 23 except that in Example 23, the azole compound was changed as shown in Table 1. In addition, the ratio A/B in each undercoat layer was determined in the same manner as in Example 23. Table 1 shows the results.

### EXAMPLES 29 AND 32

Electrophotographic photosensitive members were each produced in the same manner as in Example 26 except that in Example 26, the azole compound was changed as shown in Table 1. In addition, the ratio A/B in each undercoat layer was determined in the same manner as in Example 26. Table 1 shows the results.

### EXAMPLES 30 AND 33

Electrophotographic photosensitive members were each produced in the same manner as in Example 27 except that in Example 27, the azole compound was changed as shown in Table 1. In addition, the ratio A/B in each undercoat layer was determined in the same manner as in Example 27. Table 1 shows the results.

### EXAMPLE 34

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

15 Parts of a butyral resin “BM-1” as a polyol resin and 15 parts of a blocked isocyanate compound “Desmodur BL3575/1” whose isocyanate group had been blocked with the compound represented by the formula (1-1) were dissolved in a mixed solution of 73.5 parts of methyl ethyl ketone and 73.5 parts of 1-butanol. 81 Parts of titanium oxide particles (specific surface area: 21 m²/g, powder resistance: 6.0×10⁵ Q·cm) and 0.81 part of alizarin were added to the solution, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to prepare an undercoat-layer coating liquid. The undercoat-layer coating liquid was applied onto the support by dip coating and then the resultant coat was dried at 145° C. for 30 minutes to form an undercoat layer having a thickness of 20 μm.

### EXAMPLES 35 AND 36

Electrophotographic photosensitive members were each produced in the same manner as in Example 34 except that in Example 34, the drying conditions were changed to conditions shown in Table 1. In addition, the ratio A/B in each undercoat layer was determined in the same manner as in Example 34. Table 1 shows the results.

### EXAMPLE 37

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

15 Parts of a butyral resin “BM-1” as a polyol resin and 15 parts of a blocked isocyanate compound “Desmodur BL3575/1” whose isocyanate group had been blocked with the compound represented by the formula (1-1) were dissolved in a mixed solution of 73.5 parts of methyl ethyl ketone and 73.5 parts of 1-butanol. 81 Parts of tin oxide particles (specific surface area: 40 m²/g, powder resistance: 1.0×10⁹ Q·cm) and 0.81 part of alizarin were added to the solution, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to prepare an undercoat-layer coating liquid. The undercoat-layer coating liquid was applied onto the support by dip coating and then the resultant coat was dried at 145° C. for 30 minutes to form an undercoat layer having a thickness of 20 μm.

### EXAMPLES 38 AND 39

Electrophotographic photosensitive members were each produced in the same manner as in Example 37 except that in Example 37, the drying conditions were changed to conditions shown in Table 1. In addition, the ratio A/B in each undercoat layer was determined in the same manner as in Example 37. Table 1 shows the results.

### EXAMPLE 40

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

15 Parts of a butyral resin “BM-1” as a polyol resin and 15 parts of a blocked isocyanate compound “Sumidur BL3175” were dissolved in a mixed solution of 73.5 parts of methyl ethyl ketone and 73.5 parts of 1-butanol. Parts of titanium oxide particles (specific surface area: 21 m²/g, powder resistance: 6.0×10⁵ Q·cm), 0.81 part of alizarin, and 10.9 parts of the compound represented by the formula (1-1) were added to the solution, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to prepare an undercoat-layer coating liquid. The undercoat-layer coating liquid was applied onto the support by dip coating and then the resultant coat was dried at 145° C. for 30 minutes to form an undercoat layer having a thickness of 20 μm.

### EXAMPLES 41 TO 51

Electrophotographic photosensitive members were each produced in the same manner as in Example 40 except that in Example 40, the kind and content of the azole compound to be incorporated into the undercoat-layer coating liquid were changed as shown in Table 1, and the conditions for the drying of the undercoat layer were changed to conditions shown in Table 1. In addition, the ratio A/B in each undercoat layer was determined in the same manner as in Example 40. Table 1 shows the results.

### EXAMPLE 52

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 1 shows the result.

15 Parts of a butyral resin “BM-1” as a polyol resin and 15 parts of a blocked isocyanate compound “Sumidur BL3175” were dissolved in a mixed solution of 73.5 parts of methyl ethyl ketone and 73.5 parts of 1-butanol. 81 Parts of tin oxide particles (specific surface area: 40 m²/g, powder resistance: 1.0×10⁹ Q·cm), 0.81 part of alizarin, and 10.9 parts of the compound represented by the formula (1-1) were added to the solution, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to prepare an undercoat-layer coating liquid. The undercoat-layer coating liquid was applied onto the support by dip coating and then the resultant coat was dried at 145° C. for 30 minutes to form an undercoat layer having a thickness of 20 μm.

### EXAMPLES 53 TO 63

Electrophotographic photosensitive members were each produced in the same manner as in Example 52 except that in Example 52, the kind and content of the azole compound to be incorporated into the undercoat-layer coating liquid were changed as shown in Table 1, and the conditions for the drying of the undercoat layer were changed to conditions shown in Table 1. In addition, the ratio A/B in each undercoat layer was determined in the same manner as in Example 52.

### EXAMPLE 64

An electrophotographic photosensitive member was produced in the same manner as in Example 23 except that in Example 23, the metal oxide particles to be incorporated into the undercoat-layer coating liquid were changed from the zinc oxide particles to titanium oxide particles, and the titanium oxide particles were not subjected to a surface treatment with the silane coupling agent. In addition, the ratio A/B in the undercoat layer was determined in the same manner as in Example 23. Table 2 shows the result.

### EXAMPLE 65

An electrophotographic photosensitive member was produced in the same manner as in Example 26 except that in Example 26, the metal oxide particles to be incorporated into the undercoat-layer coating liquid were changed from the zinc oxide particles to titanium oxide particles, and the titanium oxide particles were not subjected to a surface treatment with the silane coupling agent. In addition, the ratio A/B in the undercoat layer was determined in the same manner as in Example 26. Table 2 shows the result.

### EXAMPLE 66

An electrophotographic photosensitive member was produced in the same manner as in Example 27 except that in Example 27, the metal oxide particles to be incorporated into the undercoat-layer coating liquid were changed from the zinc oxide particles to titanium oxide particles, and the titanium oxide particles were not subjected to a surface treatment with the silane coupling agent. In addition, the ratio A/B in the undercoat layer was determined in the same manner as in Example 27. Table 2 shows the result.

### EXAMPLE 67

An electrophotographic photosensitive member was produced in the same manner as in Example 23 except that in Example 23, the metal oxide particles to be incorporated into the undercoat-layer coating liquid were changed from the zinc oxide particles to tin oxide particles, and the tin oxide particles were not subjected to a surface treatment with the silane coupling agent. In addition, the ratio A/B in the undercoat layer was determined in the same manner as in Example 23. Table 2 shows the result.

### EXAMPLE 68

An electrophotographic photosensitive member was produced in the same manner as in Example 26 except that in Example 26, the metal oxide particles to be incorporated into the undercoat-layer coating liquid were changed from the zinc oxide particles to tin oxide particles, and the tin oxide particles were not subjected to a surface treatment with the silane coupling agent. In addition, the ratio A/B in the undercoat layer was determined in the same manner as in Example 26. Table 2 shows the result.

### EXAMPLE 69

An electrophotographic photosensitive member was produced in the same manner as in Example 27 except that in Example 27, the metal oxide particles to be incorporated into the undercoat-layer coating liquid were changed from the zinc oxide particles to tin oxide particles, and the tin oxide particles were not subjected to a surface treatment with the silane coupling agent. In addition, the ratio A/B in the undercoat layer was determined in the same manner as in Example 27. Table 2 shows the result.

### EXAMPLE 70

An electrophotographic photosensitive member was produced in the same manner as in Example 1 except that in Example 1, the preparation of an undercoat-layer coating liquid was performed as described below. In addition, the ratio A/B in the undercoat layer was determined in the same manner as in Example 1. Table 2 shows the result.

100 Parts of zinc oxide particles (specific surface area: 19 m²/g, powder resistance: 4.7×10⁶ Q·cm) were mixed with 500 parts of toluene by stirring. 1.5 Parts of a silane coupling agent “KBM603” were added to the mixture and then the resultant was stirred for 6 hours. After that, toluene was distilled off under reduced pressure, and then the remainder was heated and dried at 140° C. for 6 hours to provide surface-treated zinc oxide particles.

Next, a blocked isocyanate compound whose isocyanate group had been blocked with the compound represented by the formula (1-21) was synthesized with reference to Example 2 in Japanese Patent Application Laid-Open No. H10-077327.

Next, 15 parts of a butyral resin “BM-1” as a polyol resin and 15 parts of the blocked isocyanate compound were dissolved in a mixed solution of 73.5 parts of methyl ethyl ketone and 73.5 parts of 1-butanol. 81 Parts of the surface-treated zinc oxide particles and 0.41 part of 2,3,4-trihydroxybenzophenone were added to the solution, and then the mixture was dispersed with a sand mill apparatus using glass beads each having a diameter of 0.8 mm under an atmosphere having a temperature of 23±3° C. for 3 hours. After the dispersion, 0.01 part of a silicone oil “SH28PA” and 5.6 parts of crosslinked polymethyl methacrylate resin particles “TECHPOLYMER SSX-102” (average primary particle diameter: 2.5 μm) were added to the resultant, and then the mixture was stirred to prepare an undercoat-layer coating liquid. The undercoat-layer coating liquid was applied onto the support by dip coating and then the resultant coat was dried at 145° C. for 30 minutes to form an undercoat layer having a thickness of 20 μm.

### EXAMPLES 71 AND 72

Electrophotographic photosensitive members were each produced in the same manner as in Example 70 except that in Example 70, the kind of the metal oxide particles to be incorporated into the undercoat-layer coating liquid was changed as shown in Table 2, and the conditions for the drying of the undercoat layer were changed to conditions shown in Table 2. In addition, the ratio A/B in each undercoat layer was determined in the same manner as in Example 70. Table 2 shows the results.

### EXAMPLES 73 TO 77

Electrophotographic photosensitive members were each produced in the same manner as in Example 7 except that in Example 7, the kind and content of the azole compound to be incorporated into the undercoat-layer coating liquid were changed as shown in Table 2. In addition, the ratio A/B in each undercoat layer was determined in the same manner as in Example 7. Table 2 shows the results.

### EXAMPLES 78 TO 80

Electrophotographic photosensitive members were each produced in the same manner as in Example 70 except that in Example 70, the metal oxide particles to be incorporated into the undercoat-layer coating liquid were changed from the zinc oxide particles to titanium oxide particles, the titanium oxide particles were not subjected to a surface treatment with the silane coupling agent, and the conditions for the drying of the undercoat layer were changed as shown in Table 2. In addition, the ratio A/B in each undercoat layer was determined in the same manner as in Example 70. Table 2 shows the results.

### EXAMPLES 81 TO 84

Electrophotographic photosensitive members were each produced in the same manner as in Example 40 except that in Example 40, the kind and content of the azole compound to be incorporated into the undercoat-layer coating liquid were changed as shown in Table 2. In addition, the ratio A/B in each undercoat layer was determined in the same manner as in Example 40. Table 2 shows the results.

### EXAMPLES 85 TO 87

Electrophotographic photosensitive members were each produced in the same manner as in Example 70 except that in Example 70, the metal oxide particles to be incorporated into the undercoat-layer coating liquid were changed from the zinc oxide particles to tin oxide particles, the tin oxide particles were not subjected to a surface treatment with the silane coupling agent, and the conditions for the drying of the undercoat layer were changed as shown in Table 2. In addition, the ratio A/B in each undercoat layer was determined in the same manner as in Example 70. Table 2 shows the results.

### EXAMPLES 88 TO 91

Electrophotographic photosensitive members were each produced in the same manner as in Example 52 except that in Example 52, the kind and content of the azole compound to be incorporated into the undercoat-layer coating liquid were changed as shown in Table 2. In addition, the ratio A/B in each undercoat layer was determined in the same manner as in Example 52. Table 2 shows the results.

### EXAMPLE 92

An electrophotographic photosensitive member was produced in the same manner as in Example 1 except that in Example 1, the conditions for the drying of the undercoat layer were changed to conditions shown in Table 2. In addition, the ratio A/B in the undercoat layer was determined in the same manner as in Example 1. Table 2 shows the result.

### EXAMPLES 93 TO 95

Electrophotographic photosensitive members were each produced in the same manner as in Example 10 except that in Example 10, the kind and content of the azole compound to be incorporated into the undercoat-layer coating liquid were changed as shown in Table 2. In addition, the ratio A/B in each undercoat layer was determined in the same manner as in Example 10.

### EXAMPLE 96

An electrophotographic photosensitive member was produced in the same manner as in Example 34 except that in Example 34, the conditions for the drying of the undercoat layer were changed as shown in Table 2. In addition, the ratio A/B in the undercoat layer was determined in the same manner as in Example 34. Table 2 shows the result.

### EXAMPLES 97 TO 99

Electrophotographic photosensitive members were each produced in the same manner as in Example 40 except that in Example 40, the kind of the metal oxide particles to be incorporated into the undercoat-layer coating liquid and the kind and content of the azole compound were changed as shown in Table 2. In addition, the ratio A/B in each undercoat layer was determined in the same manner as in Example 40. Table 2 shows the results.

### EXAMPLE 100

An electrophotographic photosensitive member was produced in the same manner as in Example 37 except that in Example 37, the conditions for the drying of the undercoat layer were changed as shown in Table 2. In addition, the ratio A/B in the undercoat layer was determined in the same manner as in Example 37. Table 2 shows the result.

### EXAMPLES 101 TO 103

Electrophotographic photosensitive members were each produced in the same manner as in Example 52 except that in Example 52, the kind and content of the azole compound to be incorporated into the undercoat-layer coating liquid were changed as shown in Table 2. In addition, the ratio A/B in each undercoat layer was determined in the same manner as in Example 52.

### COMPARATIVE EXAMPLES 1 AND 2

Electrophotographic photosensitive members were each produced in the same manner as in Example 1 except that in Example 1, the blocked isocyanate compound to be incorporated into the undercoat-layer coating liquid was changed to a “Sumidur BL3175” and the conditions for the drying of the undercoat layer were changed as shown in Table 2. In addition, the ratio A/B in each undercoat layer was determined in the same manner as in Example 1. Table 2 shows the results.

### COMPARATIVE EXAMPLE 3

An electrophotographic photosensitive member was produced in the same manner as in Example 34 except that in Example 34, the blocked isocyanate compound to be incorporated into the undercoat-layer coating liquid was changed to a “Sumidur BL3175”. In addition, the ratio A/B in the undercoat layer was determined in the same manner as in Example 34. Table 2 shows the result.

### COMPARATIVE EXAMPLE 4

An electrophotographic photosensitive member was produced in the same manner as in Example 37 except that in Example 37, the blocked isocyanate compound to be incorporated into the undercoat-layer coating liquid was changed to a “Sumidur BL3175”. In addition, the ratio A/B in the undercoat layer was determined in the same manner as in Example 37. Table 2 shows the result.

### COMPARATIVE EXAMPLE 5

An electrophotographic photosensitive member was produced in the same manner as in Example 10 except that in Example 10, the addition of 2,4,6-trimethylpyridine was performed instead of the addition of pyrazole. In addition, the ratio A/B in the undercoat layer was determined in the same manner as in Example 10. Table 2 shows the result.

### COMPARATIVE EXAMPLE 6

An electrophotographic photosensitive member was produced in the same manner as in Example 1 except that in Example 1, no metal oxide particles were incorporated into the undercoat-layer coating liquid. In addition, the ratio A/B in the undercoat layer was determined in the same manner as in Example 1. Table 2 shows the result.

<Evaluation for Fluctuation of Light Portion Potential at the Time of Repeated Use>

Used as an evaluation apparatus was an electrophotographic copying machine manufactured by Canon Inc. (trade name: GP405, reconstructed so as to have a process speed of 300 mm/sec, its charging device was of such a system that a voltage obtained by superimposing an AC voltage on a DC voltage was applied to a roller-type contact-charging member (charging roller)). Each of the electrophotographic photosensitive members of Examples 1 to 103 and Comparative Examples 1 to 6 was mounted on the drum cartridge of the evaluation apparatus, and then an evaluation was performed as described below.

The evaluation apparatus was placed under a high-temperature and high-humidity environment having a temperature of 30° C. and a humidity of 85% RH. Charging conditions were as follows: the peak-to-peak voltage and frequency of an AC component to be applied to the charging roller were set to 1,500 V and 1,500 Hz, respectively, and a DC component to be applied thereto was set to −850 V. In addition, with regard to an exposure condition, the exposure condition was adjusted so that an initial light portion potential (Vla) before repeated use in the case of irradiation with laser exposure light became −200 V.

The surface potential of the electrophotographic photosensitive member was measured with a surface potentiometer (model 344: manufactured by TREK) by pulling a cartridge for development out of the evaluation apparatus and fixing a potential probe (trade name: model 6000B-8, manufactured by TREK) in the cartridge. The potential-measuring apparatus was constructed by placing the potential-measuring probe in the development position of the cartridge for development, and the position of the potential-measuring probe with respect to the electrophotographic photosensitive member was the center in the axial direction of the electrophotographic photosensitive member with a gap from the surface of the electrophotographic photosensitive member of 3 mm.

Next, the evaluation is described. It should be noted that the evaluation was performed in each electrophotographic photosensitive member under the initially set charging conditions and exposure condition. Each of the electrophotographic photosensitive members produced in Examples 1 to 103 and Comparative Examples 1 to was left to stand under an environment having a temperature of 30° C. and a humidity of 85% RH for 72 hours.

The cartridge for development mounted with the electrophotographic photosensitive member was attached to the evaluation apparatus and then the electrophotographic photosensitive member was repeatedly used while 50,000 sheets of A4 size plain paper were fed. After the paper feeding, the cartridge for development was left to stand for 5 minutes and then newly attached to the potential-measuring apparatus, followed by the measurement of a light portion potential (Vlb) after the repeated use. Then, the amount of fluctuation (ΔVl=|Vlb−|−|Vla|) of the light portion potential at the time of the repeated use was calculated. The Vla is the initial light portion potential before the repeated use. In addition, the |Vlb| and the |Vla| represent the absolute values of the Vlb and the Vla, respectively.

Table 1 and Table 2 show the results of the evaluation.

TABLE 1

| | | Specific | | | | | | |
|---|---|---|---|---|---|---|---|---|
| | | surface area | | Content of | | | | |
| | | of metal | | azole | | | | |
| | | oxide | Kind of | compound | | | | |
| | Metal oxide | particles | azole | in | | | Drying | |
| | particles | (m²/g) | compound | coating liquid | A/B | Binder resin | conditions | ΔVI |
| Example 1 | Zinc oxide | 19 | Formula (1-1) | 10.7 | 2.4 × 10⁻⁴ | Urethane resin | 145° C./30 min | 7 |
| Example 2 | Zinc oxide | 19 | Formula (1-1) | 10.7 | 4.8 × 10⁻⁵ | Urethane resin | 150° C./30 min | 7 |
| Example 3 | Zinc oxide | 19 | Formula (1-1) | 10.7 | 5.0 × 10⁻⁷ | Urethane resin | 145° C./60 min | 7 |
| Example 4 | Zinc oxide | 19 | Formula (1-1) | 10.7 | 4.8 × 10⁻⁴ | Urethane resin | 140° C./30 min | 7 |
| Example 5 | Zinc oxide | 19 | Formula (1-1) | 10.7 | 2.4 × 10⁻³ | Urethane resin | 140° C./25 min | 8 |
| Example 6 | Zinc oxide | 19 | Formula (1-1) | 10.7 | 1.0 × 10⁻² | Urethane resin | 130° C./35 min | 9 |
| Example 7 | Zinc oxide | 19 | Formula (1-1) | 10.7 | 1.3 × 10⁻² | Urethane resin | 130° C./35 min | 9 |
| Example 8 | Zinc oxide | 19 | Formula (1-1) | 10.7 | 1.3 × 10⁻² | Urethane resin | 130° C./35 min | 9 |
| Example 9 | Zinc oxide | 19 | Formula (1-1) | 10.7 | 1.5 × 10⁻² | Urethane resin | 130° C./35 min | 9 |
| Example 10 | Zinc oxide | 19 | Formula (1-1) | 10.9 | 2.4 × 10⁻⁴ | Urethane resin | 145° C./30 min | 7 |
| Example 11 | Zinc oxide | 19 | Formula (1-7) | 9.27 | 2.4 × 10⁻⁴ | Urethane resin | 145° C./30 min | 7 |
| Example 12 | Zinc oxide | 19 | Formula (1-7) | 0.026 | 5.0 × 10⁻⁷ | Urethane resin | 145° C./30 min | 7 |
| Example 13 | Zinc oxide | 19 | Formula (1-7) | 9.36 | 1.5 × 10⁻² | Urethane resin | 130° C./35 min | 9 |
| Example 14 | Zinc oxide | 19 | Formula (1-2) | 10.2 | 2.4 × 10⁻⁴ | Urethane resin | 145° C./30 min | 7 |
| Example 15 | Zinc oxide | 19 | Formula (1-2) | 0.028 | 5.0 × 10⁻⁷ | Urethane resin | 145° C./30 min | 7 |
| Example 16 | Zinc oxide | 19 | Formula (1-2) | 10.3 | 1.5 × 10⁻² | Urethane resin | 130° C./35 min | 9 |
| Example 17 | Zinc oxide | 19 | Formula (1-18) | 11.1 | 2.4 × 10⁻⁴ | Urethane resin | 145° C./30 min | 7 |
| Example 18 | Zinc oxide | 19 | Formula (1-18) | 0.031 | 5.0 × 10⁻⁷ | Urethane resin | 145° C./30 min | 7 |
| Example 19 | Zinc oxide | 19 | Formula (1-18) | 11.2 | 1.5 × 10⁻² | Urethane resin | 130° C./35 min | 9 |
| Example 20 | Zinc oxide | 19 | Formula (1-14) | 11.1 | 2.4 × 10⁻⁴ | Urethane resin | 145° C./30 min | 8 |
| Example 21 | Zinc oxide | 19 | Formula (1-14) | 0.031 | 5.0 × 10⁻⁷ | Urethane resin | 145° C./30 min | 7 |
| Example 22 | Zinc oxide | 19 | Formula (1-14) | 11.2 | 1.5 × 10⁻² | Urethane resin | 130° C./35 min | 9 |
| Example 23 | Zinc oxide | 18 | Formula (1-1) | 10.9 | 2.4 × 10⁻⁴ | Phenol resin | 145° C./30 min | 11 |
| Example 24 | Zinc oxide | 18 | Formula (1-1) | 0.03 | 5.0 × 10⁻⁷ | Phenol resin | 145° C./30 min | 11 |
| Example 25 | Zinc oxide | 18 | Formula (1-1) | 11.0 | 1.5 × 10⁻² | Phenol resin | 130° C./35 min | 12 |
| Example 26 | Zinc oxide | 18 | Formula (1-1) | 1.64 | 2.4 × 10⁻⁴ | Amide resin | 145° C./30 min | 12 |
| Example 27 | Zinc oxide | 18 | Formula (1-1) | 1.64 | 2.4 × 10⁻⁴ | Alkyd melamine resin | 145° C./30 min | 12 |
| Example 28 | Zinc oxide | 18 | Formula (1-7) | 9.27 | 2.4 × 10⁻⁴ | Phenol resin | 145° C./30 min | 11 |
| Example 29 | Zinc oxide | 18 | Formula (1-7) | 1.39 | 2.4 × 10⁻⁴ | Amide resin | 145° C./30 min | 13 |
| Example 30 | Zinc oxide | 18 | Formula (1-7) | 1.39 | 2.4 × 10⁻⁴ | Alkyd melamine resin | 145° C./30 min | 11 |
| Example 31 | Zinc oxide | 18 | Formula (1-2) | 10.2 | 2.4 × 10⁻⁴ | Phenol resin | 145° C./30 min | 11 |
| Example 32 | Zinc oxide | 18 | Formula (1-2) | 1.53 | 2.4 × 10⁻⁴ | Amide resin | 145° C./30 min | 13 |
| Example 33 | Zinc oxide | 18 | Formula (1-2) | 1.53 | 2.4 × 10⁻⁴ | Alkyd melamine resin | 145° C./30 min | 12 |
| Example 34 | Titanium oxide | 21 | Formula (1-1) | 10.7 | 2.4 × 10⁻⁴ | Urethane resin | 145° C./30 min | 16 |
| Example 35 | Titanium oxide | 21 | Formula (1-1) | 10.7 | 5.0 × 10⁻⁷ | Urethane resin | 145° C./60 min | 16 |
| Example 36 | Titanium oxide | 21 | Formula (1-1) | 10.7 | 1.5 × 10⁻² | Urethane resin | 130° C./35 min | 17 |
| Example 37 | Tin oxide | 40 | Formula (1-1) | 10.7 | 2.4 × 10⁻⁴ | Urethane resin | 145° C./30 min | 15 |
| Example 38 | Tin oxide | 40 | Formula (1-1) | 10.7 | 5.0 × 10⁻⁷ | Urethane resin | 145° C./60 min | 15 |
| Example 39 | Tin oxide | 40 | Formula (1-1) | 10.7 | 1.5 × 10⁻² | Urethane resin | 130° C./35 min | 16 |
| Example 40 | Titanium oxide | 21 | Formula (1-1) | 10.9 | 2.4 × 10⁻⁴ | Urethane resin | 145° C./30 min | 16 |
| Example 41 | Titanium oxide | 21 | Formula (1-1) | 0.03 | 5.0 × 10⁻⁷ | Urethane resin | 145° C./30 min | 16 |
| Example 42 | Titanium oxide | 21 | Formula (1-1) | 11.0 | 1.5 × 10⁻² | Urethane resin | 130° C./35 min | 17 |
| Example 43 | Titanium oxide | 21 | Formula (1-7) | 9.27 | 2.4 × 10⁻⁴ | Urethane resin | 145° C./30 min | 16 |
| Example 44 | Titanium oxide | 21 | Formula (1-7) | 0.026 | 5.0 × 10⁻⁷ | Urethane resin | 145° C./30 min | 16 |
| Example 45 | Titanium oxide | 21 | Formula (1-7) | 9.36 | 1.5 × 10⁻² | Urethane resin | 130° C./35 min | 17 |
| Example 46 | Titanium oxide | 21 | Formula (1-2) | 10.2 | 2.4 × 10⁻⁴ | Urethane resin | 145° C./30 min | 16 |
| Example 47 | Titanium oxide | 21 | Formula (1-2) | 0.028 | 5.0 × 10⁻⁷ | Urethane resin | 145° C./30 min | 16 |
| Example 48 | Titanium oxide | 21 | Formula (1-2) | 10.3 | 1.5 × 10⁻² | Urethane resin | 130° C./35 min | 17 |
| Example 49 | Titanium oxide | 21 | Formula (1-18) | 11.1 | 2.4 × 10⁻⁴ | Urethane resin | 145° C./30 min | 16 |
| Example 50 | Titanium oxide | 21 | Formula (1-18) | 0.031 | 5.0 × 10⁻⁷ | Urethane resin | 145° C./30 min | 16 |
| Example 51 | Titanium oxide | 21 | Formula (1-18) | 11.2 | 1.5 × 10⁻² | Urethane resin | 130° C./35 min | 17 |
| Example 52 | Tin oxide | 40 | Formula (1-1) | 10.9 | 2.4 × 10⁻⁴ | Urethane resin | 145° C./30 min | 15 |
| Example 53 | Tin oxide | 40 | Formula (1-1) | 0.03 | 5.0 × 10⁻⁷ | Urethane resin | 145° C./30 min | 15 |
| Example 54 | Tin oxide | 40 | Formula (1-1) | 11.0 | 1.5 × 10⁻² | Urethane resin | 130° C./35 min | 16 |
| Example 55 | Tin oxide | 40 | Formula (1-7) | 9.27 | 2.4 × 10⁻⁴ | Urethane resin | 145° C./30 min | 15 |
| Example 56 | Tin oxide | 40 | Formula (1-7) | 0.026 | 5.0 × 10⁻⁷ | Urethane resin | 145° C./30 min | 15 |
| Example 57 | Tin oxide | 40 | Formula (1-7) | 9.36 | 1.5 × 10⁻² | Urethane resin | 130° C./35 min | 15 |
| Example 58 | Tin oxide | 40 | Formula (1-2) | 10.2 | 2.4 × 10⁻⁴ | Urethane resin | 145° C./30 min | 15 |
| Example 59 | Tin oxide | 40 | Formula (1-2) | 0.028 | 5.0 × 10⁻⁷ | Urethane resin | 145° C./30 min | 15 |
| Example 60 | Tin oxide | 40 | Formula (1-2) | 10.3 | 1.5 × 10⁻² | Urethane resin | 130° C./35 min | 16 |
| Example 61 | Tin oxide | 40 | Formula (1-18) | 11.1 | 2.4 × 10⁻⁴ | Urethane resin | 145° C./30 min | 15 |
| Example 62 | Tin oxide | 40 | Formula (1-18) | 0.031 | 5.0 × 10⁻⁷ | Urethane resin | 145° C./30 min | 15 |
| Example 63 | Tin oxide | 40 | Formula (1-18) | 11.2 | 1.5 × 10⁻² | Urethane resin | 130° C./35 min | 16 |

TABLE 2

| | | Specific | | Content of | | | | |
|---|---|---|---|---|---|---|---|---|
| | | surface area | | azole | | | | |
| | | of metal oxide | | compound | | | | |
| | Metal oxide | particles | Kind of azole | in coating | | | Drying | |
| | particles | (m²/g) | compound | liquid | A/B | Binder resin | conditions | ΔVI |
| Example 64 | Titanium oxide | 21 | Formula (1-1) | 10.9 | 2.4 × 10⁻⁴ | Phenol resin | 145° C./30 min | 16 |
| Example 65 | Titanium oxide | 21 | Formula (1-1) | 1.64 | 2.4 × 10⁻⁴ | Amide resin | 145° C./30 min | 17 |
| Example 66 | Titanium oxide | 21 | Formula (1-1) | 1.64 | 2.4 × 10⁻⁴ | Alkyd melamine resin | 145° C./30 min | 16 |
| Example 67 | Tin oxide | 40 | Formula (1-1) | 10.9 | 2.4 × 10⁻⁴ | Phenol resin | 145° C./30 min | 15 |
| Example 68 | Tin oxide | 40 | Formula (1-1) | 1.64 | 2.4 × 10⁻⁴ | Amide resin | 145° C./30 min | 17 |
| Example 69 | Tin oxide | 40 | Formula (1-1) | 1.64 | 2.4 × 10⁻⁴ | Alkyd melamine resin | 145° C./30 min | 15 |
| Example 70 | Zinc oxide | 19 | Formula (1-21) | 7.68 | 2.4 × 10⁻⁴ | Urethane resin | 145° C./30 min | 18 |
| Example 71 | Zinc oxide | 19 | Formula (1-21) | 7.68 | 5.0 × 10⁻⁷ | Urethane resin | 145° C./60 min | 18 |
| Example 72 | Zinc oxide | 19 | Formula (1-21) | 7.68 | 1.5 × 10⁻² | Urethane resin | 130° C./35 min | 19 |
| Example 73 | Zinc oxide | 19 | Formula (1-21) | 14.4 | 4.8 × 10⁻⁴ | Urethane resin | 145° C./30 min | 18 |
| Example 74 | Zinc oxide | 19 | Formula (1-29) | 7.43 | 2.4 × 10⁻⁴ | Urethane resin | 145° C./30 min | 18 |
| Example 75 | Zinc oxide | 19 | Formula (1-29) | 0.020 | 5.0 × 10⁻⁷ | Urethane resin | 145° C./30 min | 18 |
| Example 76 | Zinc oxide | 19 | Formula (1-29) | 7.50 | 1.5 × 10⁻² | Urethane resin | 130° C./30 min | 19 |
| Example 77 | Zinc oxide | 19 | Formula (1-40) | 12.5 | 2.5 × 10⁻⁴ | Urethane resin | 145° C./30 min | 21 |
| Example 78 | Titanium oxide | 21 | Formula (1-21) | 7.68 | 2.4 × 10⁻⁴ | Urethane resin | 145° C./30 min | 20 |
| Example 79 | Titanium oxide | 21 | Formula (1-21) | 7.68 | 5.0 × 10⁻⁷ | Urethane resin | 145° C./60 min | 20 |
| Example 80 | Titanium oxide | 21 | Formula (1-21) | 7.68 | 1.5 × 10⁻² | Urethane resin | 130° C./35 min | 21 |
| Example 81 | Titanium oxide | 21 | Formula (1-21) | 14.4 | 4.8 × 10⁻⁴ | Urethane resin | 145° C./30 min | 20 |
| Example 82 | Titanium oxide | 21 | Formula (1-29) | 7.43 | 2.4 × 10⁻⁴ | Urethane resin | 145° C./30 min | 20 |
| Example 83 | Titanium oxide | 21 | Formula (1-29) | 0.020 | 5.0 × 10⁻⁷ | Urethane resin | 145° C./30 min | 20 |
| Example 84 | Titanium oxide | 21 | Formula (1-29) | 7.50 | 1.5 × 10⁻² | Urethane resin | 130° C./30 min | 21 |
| Example 85 | Tin oxide | 40 | Formula (1-21) | 7.68 | 2.4 × 10⁻⁴ | Urethane resin | 145° C./30 min | 19 |
| Example 86 | Tin oxide | 40 | Formula (1-21) | 7.68 | 5.0 × 10⁻⁷ | Urethane resin | 145° C./60 min | 19 |
| Example 87 | Tin oxide | 40 | Formula (1-21) | 7.68 | 1.5 × 10⁻² | Urethane resin | 130° C./35 min | 20 |
| Example 88 | Tin oxide | 40 | Formula (1-21) | 14.4 | 4.8 × 10⁻⁴ | Urethane resin | 145° C./30 min | 19 |
| Example 89 | Tin oxide | 40 | Formula (1-29) | 7.43 | 2.4 × 10⁻⁴ | Urethane resin | 145° C./30 min | 19 |
| Example 90 | Tin oxide | 40 | Formula (1-29) | 0.020 | 5.0 × 10⁻⁷ | Urethane resin | 145° C./30 min | 19 |
| Example 91 | Tin oxide | 40 | Formula (1-29) | 7.50 | 1.5 × 10⁻² | Urethane resin | 130° C./30 min | 20 |
| Example 92 | Zinc oxide | 23 | Formula (1-1) | 10.7 | 1.6 × 10⁻² | Urethane resin | 130° C./30 min | 23 |
| Example 93 | Zinc oxide | 23 | Formula (1-1) | 11.7 | 1.6 × 10⁻² | Urethane resin | 130° C./30 min | 23 |
| Example 94 | Zinc oxide | 23 | Formula (1-21) | 8.40 | 1.6 × 10⁻² | Urethane resin | 130° C./30 min | 24 |
| Example 95 | Zinc oxide | 23 | Formula (1-29) | 8.20 | 1.6 × 10⁻² | Urethane resin | 130° C./30 min | 24 |
| Example 96 | Titanium oxide | 21 | Formula (1-1) | 10.7 | 1.6 × 10⁻² | Urethane resin | 130° C./30 min | 26 |
| Example 97 | Titanium oxide | 21 | Formula (1-1) | 11.7 | 1.6 × 10⁻² | Urethane resin | 130° C./30 min | 26 |
| Example 98 | Titanium oxide | 21 | Formula (1-21) | 8.40 | 1.6 × 10⁻² | Urethane resin | 130° C./30 min | 28 |
| Example 99 | Titanium oxide | 21 | Formula (1-29) | 7.98 | 1.6 × 10⁻² | Urethane resin | 130° C./30 min | 28 |
| Example 100 | Tin oxide | 40 | Formula (1-1) | 10.7 | 1.6 × 10⁻² | Urethane resin | 130° C./30 min | 24 |
| Example 101 | Tin oxide | 40 | Formula (1-1) | 11.7 | 1.6 × 10⁻² | Urethane resin | 130° C./30 min | 24 |
| Example 102 | Tin oxide | 40 | Formula (1-21) | 8.40 | 1.6 × 10⁻² | Urethane resin | 130° C./30 min | 25 |
| Example 103 | Tin oxide | 40 | Formula (1-29) | 7.98 | 1.6 × 10⁻² | Urethane resin | 130° C./30 min | 25 |
| Comparative | Zinc oxide | 19 | — | — | — | Urethane resin | 160° C./30 min | 38 |
| example 1 | | | | | | | | |
| Comparative | Zinc oxide | 19 | — | — | — | Urethane resin | 145° C./30 min | 40 |
| example 2 | | | | | | | | |
| Comparative | Titanium oxide | 21 | — | — | — | Urethane resin | 145° C./30 min | 54 |
| example 3 | | | | | | | | |
| Comparative | Tin oxide | 40 | — | — | — | Urethane resin | 145° C./30 min | 50 |
| example 4 | | | | | | | | |
| Comparative | Zinc oxide | 19 | 2,4,6- | 17.9 | 2.4 × 10⁻⁴ | Urethane resin | 145° C/30 min | 52 |
| example 5 | | | Trimethylpyridine | | | | | |
| Comparative | — | — | Formula (1-1) | 10.9 | 2.4 × 10⁻⁴ | Urethane resin | 145° C./30 min | 60 |
| example 6 | | | | | | | | |

The column “content of azole compound in coating liquid” in each of Tables 1 and 2 shows the amount of the azole compound to be incorporated into the undercoat-layer coating liquid. In an example in which a blocked isocyanate compound whose isocyanate group has been blocked with an azole compound is used, the column shows the amount of the azole compound in the blocked isocyanate compound.

The results shown in Tables 1 and 2 show that when the undercoat layer of the electrophotographic photosensitive member is a layer from which the azole compound can be detected, the fluctuation of the light portion potential can be suppressed even when the member is repeatedly used for a long time period under a high-temperature and high-humidity environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-147154, filed Jun. 29, 2012, which is hereby incorporated by reference herein in its entirety.

What is claimed is:

1. An electrophotographic photosensitive member, comprising:
a support;
an undercoat layer comprising a resin and metal oxide particles, formed on the support; and
a photosensitive layer formed on the undercoat layer;
wherein the undercoat layer is a layer of which an azole compound is detected by gas chromatography analysis when the undercoat layer is heated at 150° C. for 60 minutes by headspace method, and
the azole compound is at least one selected from the group consisting of a compound represented by the following formula (1), a compound represented by the following formula (2), a compound represented by the following formula (3) and a compound represented by the following formula (4), 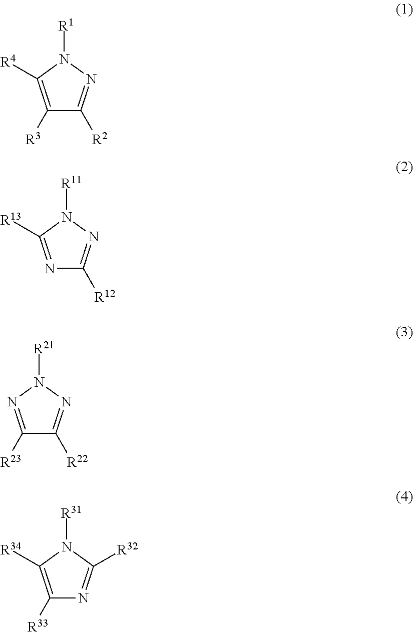
wherein, in the formulas (1) to (4),
R¹ to R⁴, R¹¹ to R¹³, R²¹ to R²³ and R³¹ to R³⁴ each independently represents a hydrogen atom or an alkyl group having 1 to 3 carbon atoms.

2. An electrophotographic photosensitive member according to claim 1,
wherein A and B satisfy the following formula (5),
5.0×10⁷≦A/B≦1.5×10² (5),
where,
A (g/cm³) represents a value that a detectable amount of the azole compound in the undercoat layer divided by a volume of the undercoat layer, when the undercoat layer is heated at 150° C. for 60 minutes by the headspace method, and
B (g/cm³) represents a value that an amount of the metal oxide particles divided by a volume of the undercoat layer.

3. An electrophotographic photosensitive member according to claim 1,
wherein the azole compound is at least one selected from the group consisting of the compound represented by the formula (1), the compound represented by the formula (2) and the compound represented by the formula (3).

4. An electrophotographic photosensitive member according to claim 1,
wherein the azole compound is the compound represented by the formula (1).

5. An electrophotographic photosensitive member according to claim 1,
wherein the metal oxide particles are particles comprising at least one selected from the group consisting of tin oxide, zinc oxide and titanium oxide.

6. An electrophotographic photosensitive member according to claim 1,
wherein the resin is an urethane resin.

7. A process cartridge detachably attachable to a main body of an electrophotographic apparatus, wherein the process cartridge integrally supports:
the electrophotographic photosensitive member according to claim 1, and
at least one device selected from the group consisting of a charging device, a developing device, a transferring device, and a cleaning device.

8. An electrophotographic apparatus comprising:
the electrophotographic photosensitive member according to claim 1;
a charging device,
an exposure device,
a developing device, and
a transferring device.

9. A method of producing an electrophotographic photosensitive member which comprises a support, an undercoat layer formed on the support and a photosensitive layer formed on the undercoat layer, comprising the steps of:
forming a coat for the undercoat layer by using an undercoat-layer coating liquid comprising metal oxide particles, an isocyanate compound, a polyol resin and an azole compound; and
heating the coat to form the undercoat layer;
wherein the azole compound is at least one selected from the group consisting of a compound represented by the following formula (1), a compound represented by the following formula (2), a compound represented by the following formula (3) and a compound represented by the following formula (4), 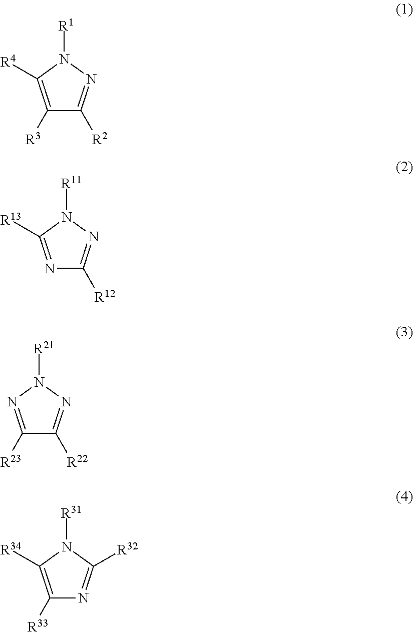
wherein, in the formulas (1) to (4),
R¹ to R⁴, R¹¹ to R¹³, R²¹ to R²³ and R³¹ to R³⁴ each independently represents a hydrogen atom or an alkyl group having 1 to 3 carbon atoms.

10. A method of producing an electrophotographic photosensitive member according to claim 9,
wherein the azole compound is at least one selected from the group consisting of the compound represented by the formula (1), the compound represented by the formula (2) and the compound represented by the formula (3).

11. A method of producing an electrophotographic photosensitive member according to claim 9, wherein the azole compound is the compound represented by the formula (1).

12. A method of producing an electrophotographic photosensitive member according to claim 9,
wherein the metal oxide particles are particles comprising at least one selected from the group consisting of tin oxide, zinc oxide and titanium oxide.

13. A method of producing an electrophotographic photosensitive member which comprises a support, an undercoat layer formed on the support and a photosensitive layer formed on the undercoat layer, comprising the steps of:
forming a coat for the undercoat layer by using an undercoat-layer coating liquid comprising metal oxide particles, a blocked isocyanate compound whose an isocyanate group has been blocked with an azole compound, and a polyol resin; and
heating the coat to form the undercoat layer;
wherein the azole compound is at least one selected from the group consisting of a compound represented by the following formula (1), a compound represented by the following formula (2), a compound represented by the following formula (3) and a compound represented by the following formula (4), 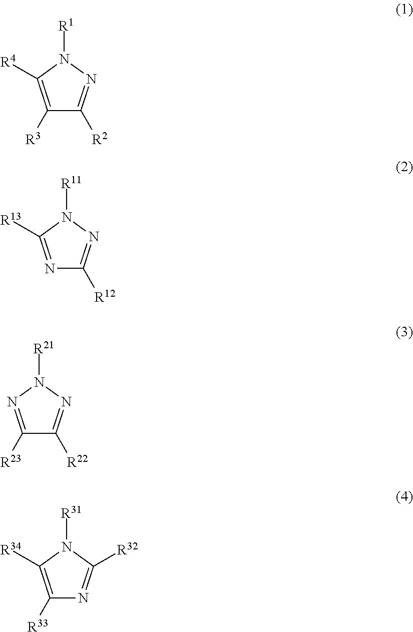
wherein, in the formulas (1) to (4),
R¹ to R⁴, R¹¹ to R¹³, R²¹ to R²³ and R³¹ to R³⁴ each independently represents a hydrogen atom or an alkyl group having 1 to 3 carbon atoms.

14. A method of producing an electrophotographic photosensitive member according to claim 13,
wherein the azole compound is at least one selected from the group consisting of the compound represented by the formula (1), the compound represented by the formula (2) and the compound represented by the formula (3).

15. A method of producing an electrophotographic photosensitive member according to claim 13,
wherein the azole compound is the compound represented by the formula (1).

16. A method of producing an electrophotographic photosensitive member according to claim 13,
wherein the metal oxide particles are particles comprising at least one selected from the group consisting of tin oxide, zinc oxide and titanium oxide.
